(19) United States
(12) Patent Application Publication
(10) Pub. No.: US 2020/0203677 A1
(43) Pub. Date: Jun. 25, 2020

(54) ELECTROCHEMICAL ELEMENT AND MANUFACTURING METHOD THEREFOR

(71) Applicants: UBATT INC., Seoul (KR); UNIST (ULSAN NATIONAL INSTITUTE OF SCIENCE AND TECHNOLOGY), Ulsan (KR)

(72) Inventors: Chang Kyoo LEE, Seoul (KR); Sang-Young LEE, Busan (KR)

(21) Appl. No.: 16/646,104

(22) PCT Filed: Sep. 10, 2018
(86) PCT No.: PCT/KR2018/010542

§ 371 Date: Mar. 10, 2020

(30) Foreign Application Priority Data
Sep. 11, 2017 (KR) 10-2017-0115918
Sep. 7, 2018 (KR) 10-2018-0107230

(51) Int. Cl. H01M 2/02; H01M 10/0585; H01M 2/08; H01M 10/0565

(52) U.S. Cl. CPC H01M 2/0287; H01M 10/0585; H01M 2/0285; H01M 2220/30; H01M 10/0565; H01M 2300/0085; H01M 2/08

(57) ABSTRACT

The present invention relates to an electrochemical device allowing charge and discharge of electric energy by an electrochemical reaction, and a method of manufacturing the same. More particularly, the present invention relates to an electrochemical device which does not require a separate terminal, and a method of continuously producing the same.

### TECHNICAL FIELD

The present invention relates to an electrochemical device allowing charge and discharge of electric energy by an electrochemical reaction, and a method of manufacturing the same. More particularly, the present invention relates to an electrochemical device which does not require a separate terminal, and a method of continuously producing the same.

### BACKGROUND ART

Recently, as an industry relating to portable electronic equipment has been expanded due to development of communication technology and semiconductor manufacturing technology, and development of alternative energy has been rapidly increasingly demanded in order to prepare for exhaustion of fossil fuels and preserve the environment, an energy-related technology has been actively researched. A battery, which is a representative energy storage device of the energy-related technology, is at the center of attention.

Among the batteries, since a lithium primary battery has a higher voltage and a higher energy density than a conventional aqueous battery, it is advantageous in terms of miniaturization and weight reduction and thus, is widely applied. The lithium primary battery is mainly used in a main power supply or a backup power supply of portable electronic equipment. A lithium secondary battery which is another battery is an energy storage device which uses an electrode material having excellent reversibility to allow charge and discharge.

The lithium secondary battery is manufactured in various shapes according to its application. For example, the lithium secondary battery is manufactured in a package having a shape such as a cylindrical, square, or pouch shape. Here, since a pouch-type secondary battery may be lightweight, technology related thereto has been steadily developed. Usually, the pouch-type lithium secondary battery may be manufactured by housing an electrode assembly inside a pouch exterior material having a space for housing the electrode assembly and then sealing the pouch exterior material to form a pouch bare cell, and attaching accessories such as a protection circuit module to the pouch bare cell to form a pouch core pack.

However, since the pouch-type lithium secondary battery is also a factor limiting the shape and the size of the lithium secondary battery in terms of packaging, and the conventional pouch lithium secondary battery includes an electrode tab, each lithium secondary battery should be manufactured by being packaged for manufacturing one lithium secondary battery, its manufacture is difficult and productivity is decreased, and it is difficult to apply the pouch-type lithium secondary battery to various electronic products.

(Patent Document 1) Korean Patent Laid-Open Publication. No. 10-2008-0034369 (Apr. 21, 2008)

### DISCLOSURE

### Technical Problem

An object of the present invention is to provide a method of manufacturing an electrochemical device, which allows continuous manufacture of the electrochemical device in the production and packaging processes, thereby having effects of mass production and reduction of production costs.

Another object of the present invention is to provide an electrochemical device, which does not require a separate terminal section, by directly closely adhering and electrically connecting a metal current collector forming an outermost layer of an electrode assembly and a metal layer forming a packaging body, and a method of manufacturing the same.

Another object of the present invention is to provide an electrochemical device, which does not require a terminal section and may be manufactured into various shapes such as circular, semicircular, triangular, tetragonal, and stellate shapes without restrictions on the design of a battery, and allows design liberalization, and a method of manufacturing the same.

Another object of the present invention is to provide an electrochemical device, in which manufacture is performed by thermal joining, using a packaging body which is continuously supplied and has a plurality of cell areas, so that a plurality of cell areas are provided in one electrochemical energy device, whereby a plurality of battery cells are continuously formed, and the battery cells may be divided to manufacture an electrochemical device having a plurality of battery cell areas at a time or to manufacture multiple battery cells, and it is easy to connect multiple battery cells electrically in series or in parallel, and a method of manufacturing the electrochemical device.

Another object of the present invention is to provide an electrochemical device which has flexibility by using an electrode assembly capable of being manufactured by a printing method, and thus, may be applied to a flexible device and also a non-plane, curved surface.

Still another object of the present invention is to provide an electrochemical device allowing a lamination thickness of each layer and the number of layers to be easily adjusted.

### Technical Solution

In one general aspect, an electrochemical element includes:

an electrode assembly housed in a space formed by an upper sheet and a lower sheet facing each other and being integrated, wherein

the upper sheet and the lower sheet include a metal layer,

at least any one or more of the upper sheet and the lower sheet include a sealing layer at the edge of the metal layer, and

current collectors of a positive electrode and a negative electrode of the electrode assembly is closely adhered and electrically connected to the metal layers of the upper sheet and the lower sheet.

In an embodiment of the electrochemical device of the present invention, a junction may be further included in at least any one or more portions in which the electrode assembly and the metal layers of the upper sheet and the lower sheet are closely adhered to each other.

In an embodiment of the electrochemical device of the present invention, any one or more layers selected from a conductive adhesive layer, a conductive pressure-sensitive adhesive layer, a conductive paste layer, and the like may be further included between any one or more metal layers selected from those of the lower sheet and the upper sheet and the electrode assembly.

In an embodiment of the electrochemical device of the present invention, any one or more selected from the upper sheet and the lower sheet may further include an insulation layer in an outermost layer, and a part of the insulation layer may be opened.

In an embodiment of the electrochemical device of the present invention, the sealing layer may be formed of a heat-fusible polymer material.

In an embodiment of the electrochemical device of the present invention, the sealing layer may include one or more layers formed of a heat-resistant material between the layers formed of the heat-fusible polymer material.

In an embodiment of the electrochemical device of the present invention, an adhesive layer may be further included on the sealing layer.

In an embodiment of the electrochemical device of the present invention, the sealing layer may be formed along a circumference of the electrode assembly at the edge excluding a portion in which the electrode assembly is disposed.

In an embodiment of the electrochemical device of the present invention, the electrode assembly includes a positive electrode and a negative electrode, and at least one or more of the positive electrode and the negative electrode may include a gel polymer electrolyte including a crosslinked polymer matrix, a solvent, and a dissociable salt.

In an embodiment of the electrochemical device of the present invention, the positive electrode may be selected from i) an electrode-electrolyte composite in which a gel polymer electrolyte is applied on the current collector, ii) an electrode-electrolyte composite in which an active material layer including an electrode active material and a binder is included on the current collector and the gel polymer electrolyte is applied on the active material layer, and iii) an electrode-electrolyte composite in which a composite active material layer including an electrode active material, a crosslinked polymer matrix, a solvent, and a dissociable salt is included on the current collector, and

the negative electrode may be selected from an electrode composed of only the current collector and i) to iii).

In an embodiment of the electrochemical device of the present invention, the positive electrode may be selected from ii) and iii), and the negative electrode may be composed of only the current collector or selected from i).

In an embodiment of the electrochemical device of the present invention, the active material layer and the composite active material layer may further include a conductive material.

In an embodiment of the electrochemical device of the present invention, the positive electrode and the negative electrode may substantially coincide on the edge.

In an embodiment of the electrochemical device of the present invention, one or more separators may be further included between the positive electrode and the negative electrode, and the separator may substantially coincide with the positive electrode and the negative electrode on the edge.

In an embodiment of the electrochemical device of the present invention, the separator may include the gel polymer electrolyte including a crosslinked polymer matrix, a solvent, and a dissociable salt.

In an embodiment of the electrochemical device of the present invention, the electrode assembly may include a first gel polymer electrolyte in the positive electrode and a second gel polymer electrolyte in the negative electrode, and the first gel polymer electrolyte and the second gel polymer electrolyte may be different from each other.

In an embodiment of the electrochemical device of the present invention, the first gel polymer electrolyte and the second gel polymer electrolyte may have a difference in solubility parameter of 0.1 Mpa^{1/2} or more.

In an embodiment of the electrochemical device of the present invention, the first gel polymer electrolyte and the second gel polymer electrolyte may have an energy level difference of 0.01 eV or more.

In an embodiment of the electrochemical device of the present invention, the first gel polymer electrolyte and the second gel polymer electrolyte may further include any one or two or more additives selected from inorganic particles and a flame retardant.

In an embodiment of the electrochemical device of the present invention, the first gel polymer electrolyte may further include a positive electrode heating inhibitor which is any one selected from succinonitrile and sebaconitrile or a mixture thereof, and

the second gel polymer electrolyte may further include an SEI layer stabilizer which is any one selected from vinylene carbonate, fluoroethylene carbonate, and catechol carbonate, or a mixture thereof.

In an embodiment of the electrochemical device of the present invention, the crosslinked polymer matrix may further include a linear polymer to form a semi-interpenetrating polymer network (IPN) structure.

In an embodiment of the electrochemical device of the present invention, each of the positive electrode current collector and the negative electrode current collector may be selectively in the form selected from the group consisting of a thin film form, a mesh form, a form in which a current collector in the form of a thin film or mesh is laminated on one surface or both surfaces of a conductive substrate and integrated therewith, and a metal-mesh composite.

In an embodiment of the electrochemical device of the present invention, the electrochemical device may be a laminate in which one or two or more electrode assemblies are laminated.

In an embodiment of the electrochemical device of the present invention, the electrode assembly may include one or more bipolar electrodes.

In an embodiment of the electrochemical device of the present invention, the sealing layer may further include a plurality of compartment partitions so that a plurality of grooves having no sealing layer formed therein are formed, and

a plurality of electrode assemblies may be included in a space formed by the upper sheet and the lower sheet facing each other and being integrated, so that a plurality of cell areas are provided.

In an embodiment of the electrochemical device of the present invention, the electrochemical device may be a primary battery or a secondary battery capable of an electrochemical reaction.

In an embodiment of the electrochemical device of the present invention, the electrochemical device may be selected from the group consisting of a lithium primary battery, a lithium secondary battery, a lithium-sulfur battery, a lithium-air battery, a sodium battery, an aluminum battery, a magnesium battery, a calcium battery, a zinc battery, a zinc-air battery, a sodium-air battery, an aluminum-air battery, a magnesium-air battery, a calcium-air battery, a super capacitor, a dye-sensitized solar battery, a fuel battery, a lead storage battery, a nickel cadmium battery, a nickel hydrogen storage battery, an alkaline battery, and the like.

In another general aspect, a method of continuously manufacturing an electrochemical device includes: supplying a lower sheet including a metal layer and a sealing layer on one surface of the metal layer, the sealing layer forming a partition pattern including a circumferential partition and a compartment partition comparting a space for housing an electrode assembly in an inner side of the circumferential partition,

laminating the electrode assembly in the space of the lower sheet for housing the electrode assembly, and

supplying an upper sheet including a metal layer and joining the sheets.

In an embodiment of the method of manufacturing an electrochemical device of the present invention, during the joining, the positive electrode current collector and the negative electrode current collector of the electrode assembly may be joined so that they are closely adhered to the metal layer of the upper sheet and the metal layer of the lower sheet, respectively.

In an embodiment of the method of manufacturing an electrochemical device of the present invention, forming a junction by welding or soldering a portion in which the metal layers of the lower sheet and the upper sheet and the electrode assembly are closely adhered to each other, after the joining, may be further included.

In an embodiment of the method of manufacturing an electrochemical device of the present invention, applying any one or more selected from a conductive adhesive, a conductive pressure-sensitive adhesive, and a conductive paste on the metal layers of the lower sheet and the upper sheet may be further included.

In an embodiment of the method of manufacturing an electrochemical device of the present invention, cutting a portion sealed by the sealing layer, after the joining, may be further included.

### Advantageous Effects

The present invention allows continuous production of a plurality of electrochemical devices, and thus, has an effect of greatly improving productivity. That is, since the electrode assembly may be manufactured by a printing method, and a packaging body having a plurality of cell areas continuously supplied is used, continuous mass production is possible.

In addition, a plurality of electrode assemblies may be laminated or an electrode assembly using an electrode in a bipolar form may be used, and thus, an electrochemical device which may be easily modified according to its use may be used.

In addition, divided electrochemical devices are easily connected in series or in parallel, and thus, may be applied to various electronic products.

In addition, since a metal layer of a packaging body and a current collector of an electrode assembly are closely adhered to each other and electrically connected in all regions, a separate terminal section is not needed to make a production process simple, and when a portion in which sealing layers are sealed is cut to be divided into battery cells, the part is cut at a desired region, so that it is possible to manufacture battery cells connected in parallel to the desired number by cutting, and thus, a battery having a desired capacity may be efficiently manufactured.

In addition, a junction is formed by a method such as welding or soldering on a region in which a metal layer of a packaging body and a current collector of an electrode assembly are closely adhered to each other, thereby manufacturing a battery having decreased contact resistance and further improved electrical performance, and providing a battery having improved charge/discharge efficiency and an improved impact characteristic.

### DESCRIPTION OF DRAWINGS

FIG. 1 illustrates a cross section of an electrochemical device according to an embodiment of the present invention.

FIG. 2 is a perspective view showing an embodiment of a lower sheet and an upper sheet of the present invention.

FIG. 3 illustrates a cross section of an electrochemical device according to an embodiment of the present invention.

FIG. 4 illustrates a cross section of an electrochemical device according to an embodiment of the present invention.

FIG. 5 illustrates a cross section of an electrochemical device according to an embodiment of the present invention.

FIG. 6 illustrates a cross section of an electrochemical device according to an embodiment of the present invention.

FIG. 7 is a cross-sectional view showing an embodiment of the lower sheet and the upper sheet of the present invention.

FIG. 8 is a cross-sectional view showing an embodiment of the lower sheet and the upper sheet of the present invention.

FIG. 9 is a cross-sectional view showing an embodiment of the lower sheet and the upper sheet of the present invention.

FIG. 10 is a perspective-sectional view showing an embodiment of the lower sheet and the upper sheet of the present invention.

FIG. 11 is a cross-sectional view showing an embodiment of an electrode assembly of the present invention.

FIG. 12 is a cross-sectional view showing an embodiment of an electrode assembly of the present invention.

FIG. 13 is a cross-sectional view showing an embodiment of an electrode assembly of the present invention.

FIG. 14 is a cross-sectional view showing an embodiment of an electrode assembly of the present invention.

FIG. 15 is a cross-sectional view showing an embodiment of an electrode assembly of the present invention.

FIG. 16 is a cross-sectional view for schematically illustrating a method of manufacturing the electrode assembly according to an embodiment of the present invention.

FIG. 17 is a perspective view for schematically illustrating a method of manufacturing the electrode assembly of the present invention.

FIG. 18 is a cross-sectional view showing an embodiment of an electrode assembly of the present invention.

FIG. 19 a cross-sectional view for schematically illustrating a method of manufacturing the electrode assembly according to an embodiment of the present invention.

### DETAILED DESCRIPTION OF MAIN ELEMENTS

206 and 306: adhesive layer

211 and 311: circumferential partition

211, 212, 311, and 312: compartment partition

213 and 313: space for housing electrode assembly

214: heat-fusible polymer material layer

215: heat-resistant material layer

400: junction

500: heating and pressing unit

401: welding unit

600: cutting unit

### BEST MODE

Hereinafter, the present invention will be described in more detail with reference to the exemplary embodiments and Examples including the accompanying drawings. However, the following exemplary embodiments and Examples are only a reference for describing the present invention in detail, and the present invention is not limited thereto, and may be implemented in various forms.

In addition, unless otherwise defined, all technical terms and scientific terms have the same meanings as those commonly understood by a person skilled in the art to which the present invention pertains. The terms used herein are only for effectively describing a certain exemplary embodiment, and not intended to limit the present invention.

In addition, the singular form used in the specification and claims appended thereto may be intended to also include a plural form, unless otherwise indicated in the context.

[Electrochemical Device]

First, the electrochemical device of the present invention will be described in detail, with reference to the drawings.

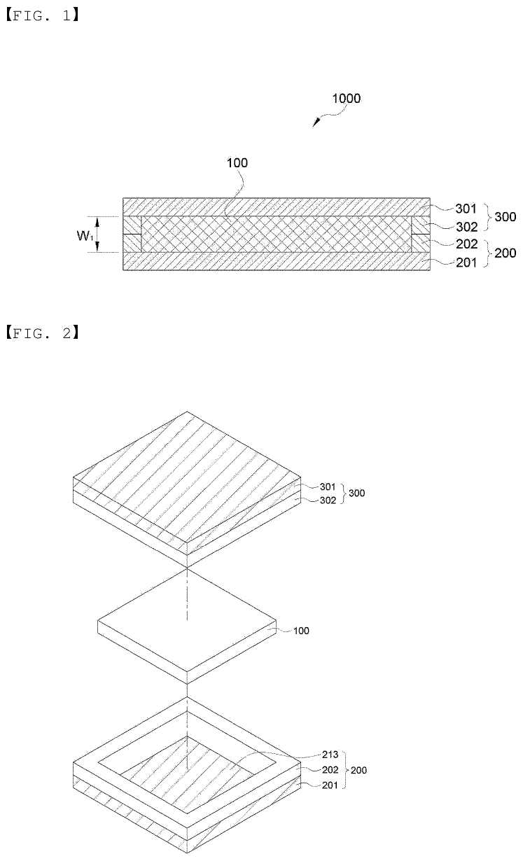

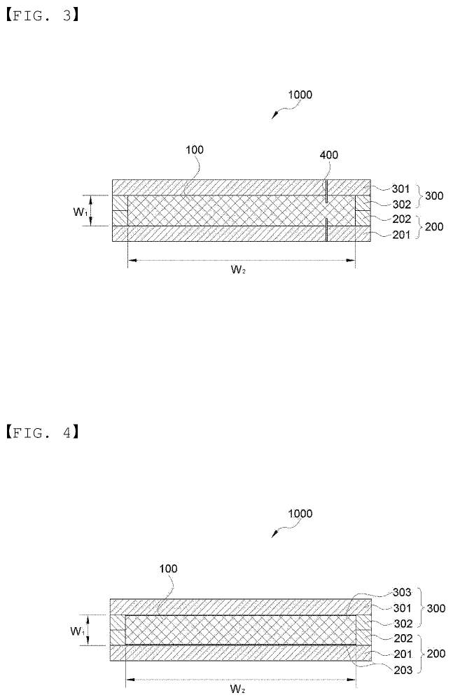

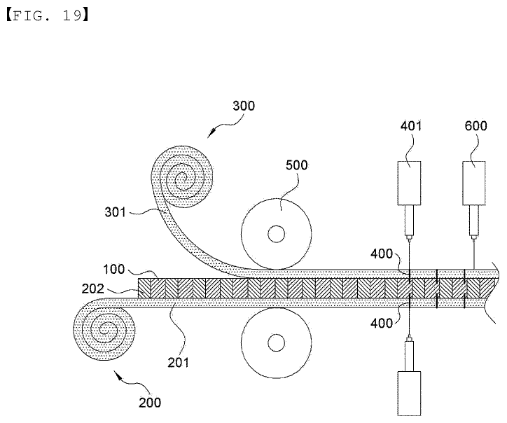

FIGS. 1 and 18 illustrate a cross section of the electrochemical device according to an embodiment of the present invention, and FIG. 2 is a perspective view showing an embodiment of the lower sheet and the upper sheet of the present invention.

FIG. 1 is the case in which a lower sheet 200 and an upper sheet 300 which form a packaging body include metal layers 201 and 301, and sealing layers 202 and 302 are included, respectively in the lower sheet 200 and the upper sheet 300, and FIG. 18 illustrates an embodiment of the case in which the lower sheet 200 and the upper sheet 300 which form the packaging body include the metal layers 201 and 301, and the sealing layer is included in either of the lower sheet 200 and the upper sheet 300. FIG. 18 is an example of the case in which a sealing layer 202 is optionally included in the lower sheet, but is not limited thereto, and the sealing layer may be included in the upper sheet.

Hereinafter, the packaging body will be described, with reference to an embodiment as in FIG. 1 including sealing layers 202 and 302 in the lower sheet 200 and the upper sheet 300, respectively, but which is only an example for detailed illustration and the present invention is not limited thereto.

In FIGS. 1 and 2, the electrochemical device 1000 of the present invention is composed of an electrode assembly 100 and a packaging body wrapping the surface thereof. The packaging body is formed by including the lower sheet 200 and the upper sheet 300. In addition, the lower sheet 200 and the upper sheet 300 include metal layers 201 and 301, sealing layers 202 and 302 formed at the edge of the metal layer, and grooves 213 and 313 having no sealing layer formed therein, in an inner side of the sealing layer.

The metal layers and the sealing layers of the lower sheet 200 and the upper sheet 300 may be formed of the same material as each other, or may be formed of different materials from each other. A specific embodiment of the packaging body will be described in more detail in FIGS. 7 to 10.

As shown in FIG. 1, an electrode assembly 100 is housed in a space formed by the sealing layers 202 and 302 of the upper sheet 300 and the lower sheet 200 facing each other and being integrated. Alternatively, as shown in FIG. 18, an electrode assembly 100 is housed in a space formed by an upper sheet 300 including a metal layer 301 and a lower sheet 200 including a metal layer 201 and a sealing layer 202 facing each other and being integrated.

The space for housing the electrode assembly 100 may have the same size as the electrode assembly 100 or may be larger than the electrode assembly 100. An extra space resulting from a space for housing the electrode assembly 100 being larger than the electrode assembly 100 acts as a buffer space for an internal pressure increase by gas or the like which may be generated during use of the electrochemical device, thereby contributing to improvement of durability and safety of the electrochemical device.

The sealing layer may be formed of a polymer material which may be fused and closed by heat, and more specifically, may be formed of a thermoplastic resin. Alternatively, the sealing layer may be formed by alternately laminating one or more layers formed of a heat-fusible polymer material and one or more layers formed of a heat-resistant material, in which the heat-resistant material may be formed of a heat-resistant resin or metal.

The electrochemical device according to an embodiment of the present invention may have the electrode assembly of which the four sides are sealed by the sealing layer. In addition, the electrode assembly 100, though not shown specifically, includes a positive electrode and a negative electrode, and the positive electrode and the negative electrode may be separated by a separator or a gel polymer electrolyte layer. In addition, a positive electrode current collector and a negative electrode current collector forming the outermost layer of the electrode assembly are characterized by being closely adhered and electrically connected to the metal layer of the upper sheet and the metal layer of the lower sheet, respectively.

In addition, since all parts of the cell may be electrically connected as such, the shape of the battery is not limited, and a terminal section is not needed. However, since the terminal section may be formed, if necessary, it is not excluded.

In addition, the electrode assembly may be continuously manufactured and may be manufactured by being cut to the desired number considering the required capacity of the battery cell. A specific embodiment of the electrode assembly 100 will be described in more detail in FIGS. 11 to 15.

Since the electrochemical device of the present invention has no separate terminal section formed, as shown in FIGS. 1 and 18, the manufacture and the use thereof are simple. In addition, as shown in FIGS. 1 and 18, in order for the positive electrode current collector and the negative electrode current collector forming the outermost part of the electrode assembly 100 to be closely adhered to the metal layer 301 of the upper sheet and the metal layer 201 of the lower sheet, the thickness (W₁) of the electrode assembly may be the same as or larger than the thickness of the sealing layers (202 and 302).

FIG. 3 illustrates a cross section of the electrochemical device according to another embodiment of the present invention. As shown in FIG. 3, an electrochemical device 1000 of the present invention may further include a junction 400 in a part or all of a portion (W₂) in which a metal layer 301 of an upper sheet 300 and a metal layer 201 of a lower sheet 200 are closely adhered to an electrode assembly 100. Since a contact resistance may be decreased by forming the junction, electrical performance is further improved, a charge/discharge efficiency is improved, and an output characteristic may be further improved. The junction 400 may be formed in the portion (W₂) in which the metal layer and the current collector of the electrode assembly are closely adhered to each other, and may be formed in a part or all of the portion, but in terms of easy manufacture, may be formed in a part. The junction 400 may be formed by welding or soldering, but is not limited thereto. The welding may be formed in the form of spot or stripe by resistance welding, ultrasonic welding, laser welding, or the like, but is not limited thereto. In addition, at the time of welding, a soldering paste may be further included inside the metal layers 201 and 301, that is, in a portion in which the electrode assembly is closely adhered.

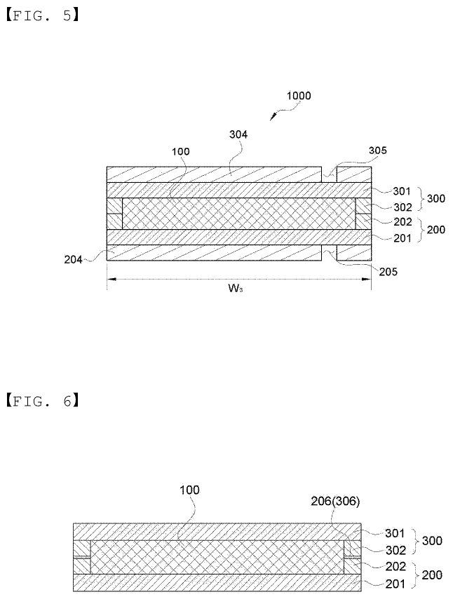

FIG. 4 illustrates a cross section of an electrochemical device according to another embodiment of the present invention. As shown in FIG. 4, an electrochemical device 1000 of the present invention may further include any one or more conductive layers 203 and 303 selected from a conductive adhesive layer, a conductive pressure-sensitive adhesive layer, a conductive paste layer, and the like in a portion (W₂) in which a metal layer 301 of an upper sheet 300 and a metal layer 201 of a lower sheet 200 are closely adhered to an electrode assembly 100. The conductive adhesive layer, the conductive pressure-sensitive adhesive layer, and the conductive paste layer are not limited as long as they are used in the art, and they allow the metal layer of the upper sheet and the metal layer of the lower sheet to be more closely adhered to the electrode assembly and have better electric conduction. In addition, though not shown, if necessary, the electrochemical device may further include a junction 400 as shown in FIG. 3.

FIG. 5 illustrates a cross section of the electrochemical device according to another embodiment of the present invention. As shown in FIG. 5, an electrochemical device 1000 of the present invention may further include insulation layers 304 and 204, respectively, on an outer surface of metal layers 201 and 301 of any one or more selected from an upper sheet 300 and a lower sheet 200. By further including the insulation layer, an electrode assembly may be protected from an external material outside the metal layer, and electrically insulated from the outside. Here, as shown in FIG. 5, the insulation layers 204 and 304 may be partially opened to include grooves 205 and 305 having no insulation formed therein. The grooves 205 and 305 may be formed in any portion (W₃) of the upper sheet 300 and the lower sheet 200, since they are electrically connected, and they may send electricity to the outside through the grooves 205 and 305. Here, a separate terminal may be further included, but the terminal may not be required.

In an embodiment of the present invention, the insulation layers 204 and 304 may be used without limitation as long as they have an electrical insulation property, and may be used without limitation as long as they protect an electrode assembly from an external material from the outside of the metal layer and may be electrically insulated from the outside. Specifically, for example, polyethylene, polypropylene, casted polypropylene (CPP), polystyrene, polyethylene terephthalate, polyvinyl chloride, polyvinylidene chloride, polyamide, a cellulose resin, a polyimide resin, and the like may be used, but the present invention is not limited thereto. In addition, one layer or two or more layers may be laminated. In addition, though not shown, if necessary, the electrochemical device may further include a junction 400 as shown in FIG. 3.

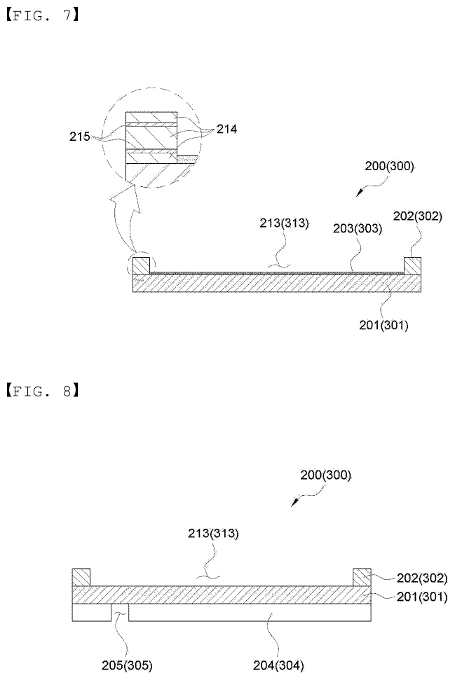

FIG. 6 illustrates a cross section of the electrochemical device according to another embodiment of the present invention. As shown in FIG. 6, an electrochemical device 1000 of the present invention may further include adhesive layers 206 and 306 on any one or more selected from a sealing layer 302 of an upper sheet 300 and a sealing layer 202 of a lower sheet 200. As described in FIG. 1, since the sealing layers 202 and 302 may be formed of a polymer material which may be fused and closed by heat, they may be melted and closed by heating and pressing using a heating plate or a heating roller, but the separate adhesive layers 206 and 306 may be formed for further improving adhesive strength. An adhesive used at this time is not limited as long as it is commonly used in the art, and may be used without limitation as long as it has an excellent adhesive property with the polymer material used in the sealing layer and excellent chemical stability with the electrode assembly. Specifically, for example, an acryl-based adhesive, an epoxy-based adhesive, a cellulose-based adhesive, and the like may be used, but the present invention is not limited thereto. In addition, though not shown, if necessary, the electrochemical device may further include a junction 400 as shown in FIG. 3.

In an embodiment of the present invention, the electrochemical device may be a primary battery or a secondary battery capable of an electrochemical reaction. More specifically, the electrochemical device may be a lithium primary battery, a lithium secondary battery, a lithium-sulfur battery, a lithium-air battery, a sodium battery, an aluminum battery, a magnesium battery, a calcium battery, a sodium-air battery, an aluminum-air battery, a magnesium-air battery, a calcium-air battery, a super capacitor, a dye-sensitized solar battery, a fuel battery, a lead storage battery, a nickel cadmium battery, a nickel hydrogen storage battery, an alkaline battery, and the like, but is not limited thereto.

[Upper Sheet and Lower Sheet]

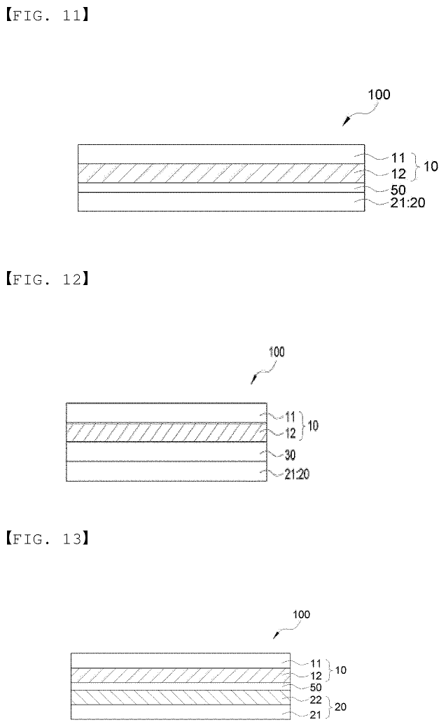

Next, the upper sheet and the lower sheet of the present invention will be described in more detail. In an embodiment of the present invention, the lower sheet 200 and the upper sheet 300 may be formed of the same material, and more specifically, the lamination configuration is as follows. The upper sheet and the lower sheet are illustrated in FIGS. 2 and 7 to 10 in more detail. Since the lower sheet and the upper sheet have the same configuration, FIGS. 2 and 7 to 10 are illustrated based on a lower sheet 200, for convenience, and the number in parentheses indicates a sign of the upper sheet 300. In addition, FIGS. 2 and 7 to 9 illustrate the lower sheet and the upper sheet included one electrochemical device manufactured by cutting, and FIG. 10 illustrates an example of the lower sheet and the upper sheet which are continuously supplied from a roll, for manufacturing a plurality of battery cells in the manufacturing method of the present invention.

The lower sheet 200 and the upper sheet 300 may include metal layers 201 and 301, sealing layers 202 and 302 formed the edge of the metal layers, and grooves 213 and 313 having no sealing layer formed therein, in an inner side of the sealing layers, as shown in FIG. 2. The grooves 213 and 313 having no sealing layer formed therein are for housing an electrode assembly 100, and the form of the groove may be formed along a circumference of the electrode assembly. In addition, a size of a cross section the grooves 212 and 313 may be the same as or larger than a size of the electrode assembly 100.

In an embodiment of the present invention, since the metal layers 201 and 301 form a packaging body of the electrochemical device, it is preferred that the metal layers are formed of a material which has mechanical strength and may prevent inflow of gas and moisture. The metal is not particularly limited as long as it may be used in the art, but specifically, for example, the metal may be aluminum, copper, stainless steel, nickel, nickel-plated iron, an alloy of two or more thereof, a clad metal in which two or more metals thereof are laminated, or the like. Among these, aluminum is preferred, since it has a light weight, excellent mechanical strength, and excellent stability to electrochemical properties of the electrode assembly and an electrolyte, but the present invention is not limited thereto. The thickness of the metal layer is not limited, but may be 0.1 to 200 m, and more specifically 1 to 100 μm, from the viewpoint of preventing porosity and permeation of water and the like at the time of forming the junction.

In an embodiment of the present invention, the sealing layer may be formed of any material without limitation as long as the material may be melted and sealed by heat, and a material having an excellent adhesive property to the metal layer is more preferably used. Specifically, for example, polyethylene, polypropylene, casted polypropylene (CPP), anhydrous maleic acid-grafted polyethylene, anhydrous maleic acid-grafted polypropylene, polystyrene, polyethylene terephthalate, polyvinyl chloride, polyvinylidene chloride, polyamide, a cellulose resin, a resin prepared by compounding two or more thereof, and the like may be used, but the present invention is not limited thereto. In addition, one layer or two or more layers may be laminated.

When the thickness of the sealing layer is too small or a sealing temperature is too high, the sealing layers 202 and 302 becomes too thin or are melted during sealing by applying heat to a sealing part, so that the metal layers 201 and 301 may be adhered to each other to cause short. Therefore, as shown in FIG. 7, the sealing layer of the present invention may further include a layer 215 formed of a heat-resistant material, thereby preventing short occurrence during sealing and sufficiently acting as a spacer. More specifically, the sealing layer may include one or more layers 215 formed of a heat-resistant material between the layers 214 formed of the heat-fusible polymer material. That is, a lamination order may be a heat-fusible polymer material/heat-resistant material/heat-fusible polymer material, and the like. The number of laminated layers and the thickness thereof are not limited. The heat-resistant material may be formed of metal such as aluminum, heat-resistant resins such as nylon, polyethylene terephthalate, polyphenylene sulfide, polypropylene, polyimide, polyamideimide, or the like, but is not limited thereto. It is preferred that the thickness of the heat-resistant material is smaller than the thickness (W₁) of the entire sealing part.

FIGS. 7 to 9 are cross-sectional views showing another embodiment of the lower sheet and the upper sheet of the present invention.

As shown in FIG. 7, at least any one or more of the lower sheet 200 and the upper sheet 300 include metal layers 201 and 301, sealing layers 202 and 302 formed at the edge of the metal layers, and grooves 213 and 313 having no sealing layer formed therein, in an inner side of the sealing layers, and any one or more conductive layers 203 and 303 selected from a conductive adhesive layer, a conductive pressure-sensitive adhesive layer, and a conductive paste layer may be formed in the grooves 213 and 313. The conductive adhesive layers 203 and 303 increase close adhesive strength between the electrode assembly and the metal layer, thereby improving electrical connection. The conductive adhesive layer, the conductive pressure-sensitive adhesive layer, and the conductive paste layer may be used without limitation as long as they are commonly used in the art. The thickness of any one or more selected from the conductive adhesive layer, the conductive pressure-sensitive adhesive layer, and the conductive paste layer is not limited, but specifically, for example, may be 0.1 to 10 μm.

More specifically, the conductive adhesive may be formed of a metal powder, a conductive material, a binder, and the like. That is, a mixture of binders composed of a metal powder such as silver, zinc, and copper; a conductive material such as a metal fiber, a carbon powder, a carbon fiber, and carbon-based particles such as carbon nanotubes; and a polymer material such as an acryl-based resin, an epoxy-based resin, a urethane-based resin, a cellulose-based resin, an adhesive polyolefin resin, specifically, anhydrous maleic acid-grafted polyolefin, and acrylic acid-grafted polyolefin, may be used. A size of the metal powder and the carbon powder used may be 10 nm to 10 μm. A diameter of the metal fiber and the carbon fiber may be 10 nm to 10 μm, and a length thereof may be 10 μm to 30 mm, but the present invention is not limited thereto.

In addition, as described above, the sealing parts 202 and 302 of the present invention further include a layer 215 formed of a heat-resistant material, thereby preventing occurrence of short during sealing and sufficiently acting as a spacer.

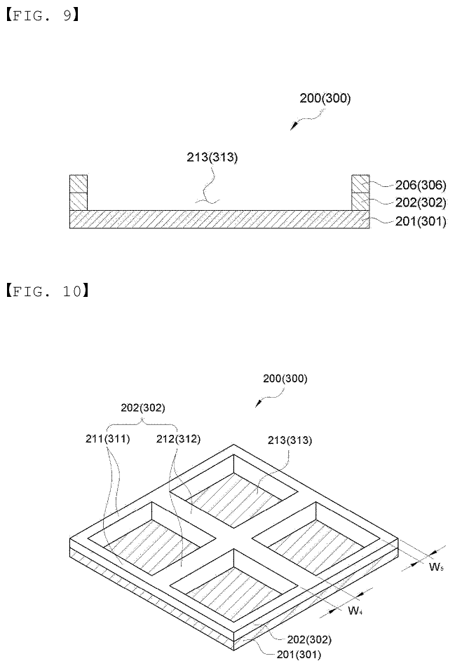

As shown in FIG. 8, the lower sheet 200 and the upper sheet 300 may include metal layers 201 and 301, sealing layers 202 and 302 formed at the edge of the metal layers, and a groove 213 having no sealing layer formed therein, in an inner side of the sealing layer, and further include insulation layers 204 and 304 on an opposite surface to a surface on which the sealing layer is formed. Here, a part of the insulation layer may be opened to include grooves 205 and 305 having no insulation layer formed therein. The grooves 205 and 305 may be formed in any one or more selected from the upper sheet 300 and the lower sheet 200, or may be formed in a part thereof. Electricity may be sent to the outside through the grooves 205 and 305. In an embodiment of the present invention, the insulation layer may be used without limitation as long as they have an electrical insulation property, and may be used without limitation as long as they protect an electrode assembly from an external material from the outside of the metal layer and may be electrically insulated from the outside. Specifically, for example, polyethylene, polypropylene, casted polypropylene (CPP), polystyrene, polyethylene terephthalate, polyvinyl chloride, polyvinylidene chloride, polyimide, polyamide, cellulose resin, and the like may be used, but the present invention is not limited thereto. In addition, one layer or two or more layers may be laminated.

In addition, the thickness of the insulation layer is not limited, and specifically, for example, may be 0.1 to 50 μm.

As shown in FIG. 9, the lower sheet 200 and the upper sheet 300 may include metal layers 201 and 301, sealing layers 202 and 302 formed at the edge of the metal layers, and grooves 213 and 313 having no sealing layer formed therein, in an inner side of the sealing layer, and further include adhesive layers 206 and 306 on the sealing layers 202 and 302. The sealing layers 202 and 302 may be formed of a polymer material which may be fused or closed by heat, or include one or more layers formed of a heat-resistant material between layers formed of a heat-fusible polymer material. In addition, by heating and compressing the sealing layers using a heating plate or a heating roller, the sealing layers 202 and 302 may be melted and closed, but a separate adhesive layers 206 and 306 may be formed for further improving adhesive strength. An adhesive used at this time is not limited as long as it is commonly used in the art, and may be used without limitation as long as it has an excellent adhesive property with the polymer material used in the sealing layer and excellent chemical stability with the electrode assembly. Specifically, for example, an acryl-based adhesive, an urethane-based resin, an epoxy-based adhesive, and the like may be used, but the present invention is not limited thereto.

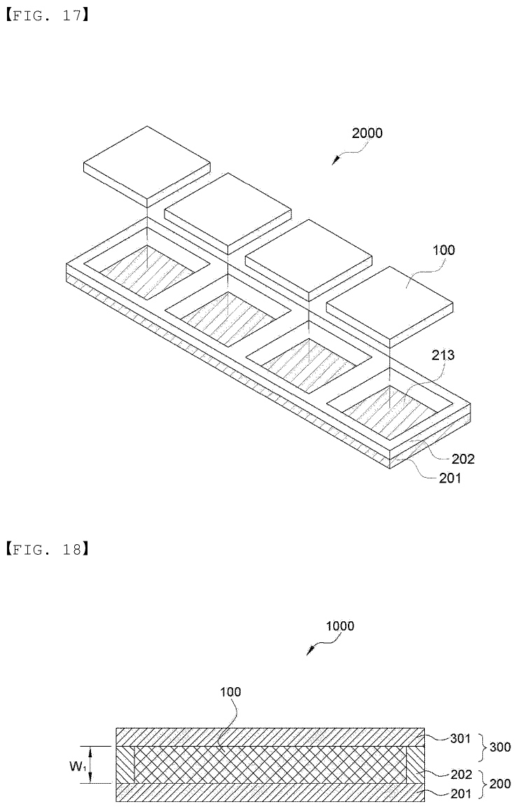

FIG. 10 is a perspective view showing an embodiment of the lower sheet and the upper sheet which are continuously supplied in a roll, for manufacturing a plurality of electrochemical devices in the present invention. As shown in FIG. 10, metal layers 201 and 301, and sealing layers 202 and 302 forming a partition pattern including circumferential partitions 211 and 311 and compartment partitions 212 and 312 for comparting spaces 213 and 313 for housing an electrode assembly in an inner side of the circumferential partition on one surface of the metal layers may be included. FIG. 10 is illustrated as having four spaces for convenience as an embodiment for showing that a plurality of spaces for housing the electrode assembly are formed, but is not limited thereto. In addition, the number of battery cells may be cut as necessary to manufacture an electrochemical device composed of one battery cell (FIGS. 1 and 18) or an electrochemical device composed of a plurality of battery cells (FIG. 17), as shown in FIG. 1 or 17. Here, the thickness (W₄) of the compartment partitions 212 and 312 may be formed to be larger than the thickness (W₅) of the circumferential partitions 211 and 311 for easy cutting. That is, the electrochemical device may be an electrochemical device 1000 composed of one battery cell or an electrochemical device 2000 in which a plurality of battery cells are connected.

[Electrode Assembly]

In an embodiment of the present invention, when an electrode assembly including a positive electrode and a negative electrode is set as one set, one or more sets may be laminated. In addition, one or more gel polymer electrolyte layers or one or more separators may be included between the positive electrode and the negative electrode. Alternatively, an electrode in a bipolar form in which the positive electrode and the negative electrode are formed on both surfaces may be included on one current collector.

In an embodiment of the present invention, the electrode assembly includes a positive electrode and a negative electrode, and at least one or more of the positive electrode and the negative electrode may include a gel polymer electrolyte including a crosslinked polymer matrix, a solvent, and a dissociable salt to form an electrode-electrolyte composite. That is, it is possible to inject a liquid electrolyte into the electrode assembly of the present invention in the state in which the positive electrode, the separator, and the negative electrode are laminated, but preferably, the gel polymer electrolyte composition may be applied to any one or more selected from the positive electrode and the negative electrode to manufacture a positive electrode-electrolyte composite or a negative electrode-electrolyte composite, and since manufacture may be performed by the application as such, continuous manufacture is possible.

In addition, in the electrode assembly of an embodiment of the present invention, the positive electrode and the negative electrode may substantially coincide on the edge. The term, “substantially” means that an error range is within ±10 μm. That is, “substantially coinciding on the edge” means completely coinciding or coinciding within an error range of ±10 μm.

In addition, in an embodiment of the present invention, the electrode assembly further includes one or more separators between the positive electrode and the negative electrode, and the separator may substantially coincide with the positive electrode and the negative electrode on the edge. In addition, when the electrode assembly includes the separator between the positive electrode and the negative electrode as described above, the separator may include a liquid electrolyte or a gel polymer electrolyte.

For the electrode assembly according to an embodiment of the present invention, since the positive electrode and the negative electrode may be manufactured by a coating method, and the electrode assembly may be manufactured by a method such as punching in the state in which the positive electrode, the separator, and the negative electrode are laminated, sizes of the positive electrode, the separator, and the negative electrode may be substantially the same. Specifically, the electrolyte assembly may be laminated by applying and curing the gel polymer electrolyte composition in the state in which the positive electrode and the separator are laminated, to include the gel polymer electrolyte in the positive electrode and the separator, and laminating the negative electrode thereto, and since the entire process is performed by an application method, continuous manufacture is possible and a manufacturing time is much shortened.

<Positive Electrode>

In an embodiment of the present invention, the positive electrode may be formed in various embodiments, and for example, may be selected from an electrode composed of only a current collector, an electrode in which an active material layer including a positive electrode active material and a binder is coated on a current collector, and a composite electrode in which a composite active material layer including a positive electrode active material, a crosslinked polymer matrix, and a liquid electrolyte is coated on a current collector. More preferably, the positive electrode may include a liquid electrolyte or a gel polymer electrolyte from the viewpoint of improving ion conductivity. In the case of the electrode including an active material layer, a liquid electrolyte or a gel polymer electrolyte is applied on the active material layer so that the active material layer is impregnated partially or wholly or included in a surface layer. In addition, when the electrode is composed of a crosslinked polymer matrix, a close adhesive strength or an interface adhesive strength to the gel polymer electrolyte layer may be further improved, which is thus preferred, but the present invention is not limited thereto.

More specifically, for example, the positive electrode may be selected from i) an electrode-electrolyte composite in which a gel polymer electrolyte is applied on the current collector, ii) an electrode-electrolyte composite in which an active material layer including an electrode active material and a binder is included on the current collector and the gel polymer electrolyte is applied on the active material layer, iii) an electrode-electrolyte composite in which a composite active material layer including an electrode active material, a crosslinked polymer matrix, a solvent, and a dissociable salt is included on the current collector, and iv) an electrode-electrolyte composite in which a gel polymer electrolyte is applied on the composite active material layer of iii).

More preferably, the positive electrode may be selected from ii) and iii) above.

The current collector is not limited as long as it is a substrate having excellent conductivity used in the art, and may be formed of a material including any one selected from conductive metals, conductive metal oxides, and the like. In addition, the current collector may be in the form in which the entire substrate is formed of a conductive material or one surface or both surfaces of an insulating substrate are coated with a conductive metal, a conductive metal oxide, a conductive polymer, or the like. In addition, the current collector may be composed of a flexible substrate, and may be easily bent, thereby providing a flexible electronic device. In addition, the current collector may be formed of a material having a restoring force which acts to return a material to its original form after bending the material. In addition, the current collector may be in the form selected from the group consisting of a thin film form, a mesh form, a form in which a current collector in the form of a thin film or mesh is laminated on one surface or both surfaces of a conductive substrate and integrated therewith, and a metal-mesh composite. The metal-mesh composite means that a metal in the form of a thin film and a metal or a polymer material in the form of mesh are heated and compressed to be integrated, whereby the metal thin film is put between the holes of the mesh and integrated, and the metal thin film is not broken or does not crack even when the metal thin film is bent. As such, when the metal-mesh composite is used, crack occurrence in the current collector at the time of bending or charging/discharging a battery may be prevented, which is thus more preferred, but the present invention is not limited thereto. More specifically, for example, the current collector may be formed of aluminum, stainless steel, copper, nickel, iron, lithium, cobalt, titanium, nickel foam, copper foam, a conductive metal-coated polymer substrate, a composite thereof, and the like, but is not limited thereto.

The embodiment ii) of the positive electrode of the present invention may be a form in which a positive electrode active material composition including a positive electrode active material and a binder is applied on a current electrode to coat the current electrode with an active material layer. In addition, a composition for forming a gel polymer electrolyte may be applied on the active material layer, thereby being impregnated into the active material layer to coat a part or all of the active material layer, or may be applied to the surface to form the gel polymer electrolyte. More specifically, a gel polymer electrolyte composition including a crosslinkable monomer and a derivative thereof, an initiator, and a liquid electrolyte is coated on a positive electrode, and ultraviolet rays or heat is applied thereto to perform crosslinking, thereby uniformly distributing the liquid electrolyte and the like in a network structure of a crosslinked polymer matrix, and a process of evaporating a solvent may not be needed. In addition, the crosslinked polymer matrix may further include a linear polymer to form a semi-interpenetrating polymer network (IPN) structure. More detailed description of the gel polymer electrolyte will be provided in the following.

The current collector is as described above, and the positive electrode active material composition is directly coated on the current collector such as aluminum and dried, thereby forming a positive electrode plate on which the positive electrode active material layer is formed. Here, the coating may be performed by a printing method such as inkjet printing, gravure printing, gravure offset, aerosol printing, stencil printing, and screen printing as well as a coating method such as bar coating, spin coating, slot die coating, and dip coating.

Alternatively, the positive electrode having a positive electrode active material layer formed thereon may be manufactured by casting the positive electrode active material composition on a separate support, peeling off a film from the support, and laminating the obtained film on the current collector. The thickness of the positive electrode active material layer is not limited, but may be 0.01 to 500 μm, and more specifically 1 to 200 μm, but is not limited thereto.

The positive electrode active material composition is not limited, but may include a positive electrode active material, a binder, and a solvent, and further include a conductive material.

The positive electrode active material may be used without limitation as long as it is commonly used in the art. Specifically, for example, in a lithium primary battery or lithium secondary battery, a compound capable of reversible intercalation and deintercalation of lithium (lithiated intercalation compound) may be used. The positive electrode active material of the present invention may be in the form of powder.

Specifically, one or more of composite oxides of a metal composed of any one selected from cobalt, manganese, nickel, and the like, or a combination of two or more and lithium may be used. Though not limited thereto, as a specific example, a compound represented by any one of following Chemical Formulae may be used: LiₐA_{1-b}R_{b}D₂ (wherein 0.90≤a≤1.8 and 0≤b≤0.5); LiₐE_{1-b}R_{b}O_{2-c}D_{c} (wherein 0.90≤a≤1.8, 0≤b≤0.5, and 0≤c≤0.05); LiE_{2-b}R_{b}O_{4-c}D_{c} (wherein 0≤b≤0.5 and 0≤b≤0.5); LiₐNi_{i-b-c}Co_{b}R_{c}D_{α}, (wherein 0.90≤a≤1.8, 0≤b≤0.5, 0≤c≤0.05, and 0<α<2); LiₐNi_{1-b-c}Co_{b}R_{c}O_{2-α}Z_{α} (wherein 0.90 ≤a≤1.8, 0.90≤a≤0.5, ≤c≤0.05, and 0<α<2); LiₐNi_{i-b-c}Co_{b}R_{c}O_{2-α}Z₂ (wherein 0.90≤a≤1.8, 0≤b≤0.5, 0≤c≤0.05, and 0<α<2); LiₐNi_{1-b-c}Mn_{b}R_{c}D_{α} (wherein 0.90≤a≤1.8, 0=b≤0.5, 0≤c≤0.05, and 0<α<2); LiₐNi_{1-b-c}Mn_{b}R_{c}O_{2-α}Z_{α} (wherein 0.90≤a≤1.8, 0≤b≤0.5, 0≤c≤0.05, and 0<α<2); LiₐNi_{1-b-c}Mn_{b}R_{c}O_{2-α}Z₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001=d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂GbO₄ (wherein 0.90≤a≤1.8 and 0.001≤b≤0.1); QO₂; QS₂; LiQS₂; V₂O₅; LiV₂O₅; LiTO₂; LiNiVO₄; Li_{(3-f)}J₂(PO₄)₃ (0≤f≤2); Li_{(3-f)}Fe₂(PO₄)₃ (0≤f≤2); and LiFePO₄.

In the above Chemical Formulae, A is Ni, Co, Mn, or a combination thereof; R is Al, Ni, Co, Mn, Cr, Fe, Mg, Sr, V, rare earth elements, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

Of course, a compound having a coating layer on the surface may be used or a mixture of the compound and the compound having a coating layer may be used. The coating layer may include an oxide or hydroxide of a coating element, an oxyhydroxide of a coating element, an oxycarbonate of a coating element, or a hydroxycarbonate of a coating element, as a coating element compound. The compound forming the coating layer may be amorphous or crystalline. As the coating element included in the coating layer, Mg, Al, Co, K, Na, Ca, Si, Ti, V, Sn, Ge, Ga, B, As, Zr, a mixture thereof may be used. As a process of forming the coating layer, any coating method may be used as long as the method does not adversely affect the physical properties of the positive electrode active material when using these elements in the compound, for example, spray coating, a dipping method, and the like, and since a person skilled in the art will understand it well, detailed description therefor will be omitted.

Though not limited thereto, the positive electrode active material may be included at 20 to 99 wt %, more preferably 30to 95 wt %, in the total weight of the composition. In addition, the positive electrode active material may have an average particle diameter of 0.001 to 50 μm, more specifically 0.01to 20 μm, but is not limited thereto.

The binder serves to adhere positive electrode active material particles to each other and fix the positive electrode active material to the current collector. Any binder commonly used in the art may be used without limitation, and representative examples thereof include polyvinyl alcohol, carboxymethyl cellulose, hydroxypropyl cellulose, polyvinyl chloride, carboxylated polyvinyl chloride, polyvinyl fluoride, a polymer including ethylene oxide, polyvinylpyrrolidine, polyurethane, polytetrafluoroethylene, polyvinylidene fluoride, polyethylene, polypropylene, a styrene-butadiene rubber, an acrylated styrene-butadiene rubber, an epoxy resin, nylon, and the like alone or in combination of two or more, but are not limited thereto. Though not limited thereto, the content of the binder may be 0.1to 20 wt %, more preferably to 10 wt %, in the total weight of the composition. Within the range, the binder sufficiently serves the function, but is not limited thereto.

The solvent may be any one selected from N-methyl pyrrolidone, acetone, water, and the like or a mixture of two or more thereof, but is not limited thereto, and any solvent commonly used in the art may be used. The content of the solvent is not limited, and the content allowing coating on the positive electrode current collector in a slurry state may be used without limitation.

In addition, the positive electrode active material composition may further include a conductive material.

The conductive material is used for imparting conductivity to an electrode and may be used without limitation as long as it is an electroconductive material without causing a chemical change in the configured battery. Specifically, for example, a conductive material including carbon-based materials such as natural graphite, artificial graphite, carbon black, acetylene black, ketjen black, carbon nanotubes, and carbon fiber; metal-based materials such as metal powder or metal fiber of copper, nickel, aluminum, silver, and the like; conductive polymers such as a polyphenylene derivative; or a mixture thereof may be used alone or in combination of two or more.

The content of the conductive material may be 0.1 to 20 wt %, specifically 0.5to 10 wt %, and more specifically 1 to 5 wt %, in the positive electrode active material composition, but is not limited thereto. In addition, an average particle diameter of the conductive material may be 0.001to 1000 μm, more specifically 0.01to 100 μm, but is not limited thereto.

The gel polymer electrolyte composition may be coated on the positive electrode by a printing method such as roll-to-roll printing, inkjet printing, gravure printing, gravure offset, aerosol printing, and screen printing, so that continuous manufacture is possible. The gel polymer electrolyte may be obtained by light-crosslinking or heat-crosslinking a crosslinkable monomer and a derivative thereof by an initiator to form a crosslinked polymer matrix. The mechanical strength and the structural stability of the gel polymer electrolyte layer are improved by crosslinking, and when the gel polymer electrolyte is coupled to the positive electrode of the embodiment described above, structural stability of the gel polymer electrolyte layer and the positive electrode interface may be further improved.

It is preferred that the gel polymer electrolyte composition has a viscosity appropriate for a printing process, and specifically, for example, has a viscosity of 0.1to 10,000,000 cps, preferably 1.0to 1,000,000 cps, and more preferably 1.0to 100,000 cps, as measured by a brookfield viscometer at 25° C., and within the range, the viscosity is suitable for being applied to a printing process, and thus, the range is preferred, but the present invention is not limited thereto.

The gel polymer electrolyte composition may include 1 to 50 wt %, specifically 2to 40 wt % of a crosslinkable monomer and a derivative thereof in total 100 wt % of the composition, but is not limited thereto. The initiator may be included at 0.01to 50 wt %, specifically 0.01to 20 wt %, and more specifically 0.1to 10 wt %, but is not limited thereto. The liquid electrolyte may be included at 1to 95 wt %, specifically 1to 90 wt %, and more specifically 2 to 80 wt %, but is not limited thereto.

As the crosslinkable monomer, a monomer having two or more functional groups or a mixture of a monomer having two or more functional groups and a monomer having one functional group may be used, and any light-crosslinkable or heat-crosslinkable monomer may be used without limitation.

Specific examples of the monomer having two or more functional groups include any one selected from polyethyleneglycol diacrylate, polyethyleneglycol dimethacrylate, triethyleneglycol diacrylate, triethyleneglycol dimethacrylate, trimethylolpropane ethoxylate triacrylate, trimethylolpropane ethoxylate trimethacrylate, bisphenol A ethoxylate diacrylate, bisphenol A ethoxylate dimethacrylate, and the like, or a mixture of two or more.

In addition, the monomer having one functional group may be any one selected from methylmethacrylate, ethylmethacrylate, butylmethacrylate, methylacrylate, butylacrylate, ethyleneglycol methyletheracrylate, ethyleneglycol methylethermethacrylate, acrylonitrile, vinylacetate, vinylchloride, vinylfluoride, and the like, or a mixture of two or more.

As the initiator, any initiator may be used without limitation as long as it is a photoinitiator or thermal initiator commonly used in the art.

The liquid electrolyte may include a dissociable salt and a solvent.

Though not limited thereto, specific examples of the dissociable salt include any one selected from lithium hexafluorophosphate (LiPF₆), lithium tetrafluoroborate (LiBF₄), lithium hexafluoroantimonate (LiSbF₆), lithium hexafluoroacetate (LiAsF₆), lithium difluoromethanesulfonate (LiC₄F₉SO₃), lithium perchlorate (LiClO₄), lithium aluminate (LiAlO₂), lithium tetrachloroaluminate (LiAlCl₄), lithium chloride (LiCl), lithium iodide (LiI), lithium bisoxalatoborate (LiB(C₂O₄)₂), lithium tri fluoromethanesulfonylimide (LiN(CₓF₂ₓ₊₁SO₂) (C_{y}F_{2y+1}SO₂)) (wherein x and y are a natural number), and derivatives thereof, or a mixture of two or more. The concentration of the dissociable salt may be 0.1 to 10.0 M, more specifically 1to 5 M, but is not limited thereto.

As the solvent, any one selected from organic solvents such as carbonate-based solvents, nitrile-based solvents, ester-based solvents, ether-based solvents, ketone-based solvents, glyme-based solvents, alcohol-based solvents, and nonprotic solvents, and water, or a mixed solvent of two or more may be used.

In addition, the crosslinked polymer matrix of the gel polymer electrolyte may further include a linear polymer to form a semi-interpenetrating polymer network (semi-IPN) structure. In this case, the positive electrode-electrolyte combination has excellent flexibility and when used in a battery, shows strong resistance to stress such as bending, thereby allowing the battery to normally drive without deterioration of performance. Therefore, the positive electrode-electrolyte combination may be more advantageous to application to a flexible battery and the like.

The linear polymer is easily mixed with the crosslinkable monomer, and may be used without limitation as long as it may be impregnated into a liquid electrolyte. Specifically, for example, the linear polymer may be any one selected from poly(vinylidene fluoride) (PVdF), poly(vinylidene fluoride)-co-hexafluoropropylene (PVdF-co-HFP), polymethylmethacryalte (PMMA), polystyrene (PS), polyvinylacetate (PVA), polyacrylonitrile (PAN), polyethylene oxide (PEO), and the like, or a combination of two or more, but is not limited thereto.

The linear polymer may be included at 1to 90 wt % with respect to the weight of the crosslinked polymer matrix. Specifically, the linear polymer may be included at 1to 80 wt %, 1to 70 wt %, 1to 60 wt %, 1to 50 wt %, 1 to 40 wt %, or 1to 30 wt %. That is, when the polymer matrix has a semi-interpenetrating polymer network (semi-IPN) structure, the crosslinkable polymer and the linear polymer may be included in a range of a weight ratio of 99:1to 10:90. When the linear polymer is included in the above range, the crosslinked polymer matrix may secure flexibility while retaining appropriate mechanical strength. Accordingly, when the linear polymer is applied to a flexible battery, stable battery performance may be implemented even in the case of shape deformation by various external forces, and may suppress danger such as battery fire and explosion resulting from shape deformation of a battery.

In addition, the gel polymer electrolyte composition may further include inorganic particles, if necessary, The inorganic particles allow printing by controlling rheological properties such as viscosity of the gel polymer electrolyte composition. The inorganic particles may be used for improving ion conductivity of an electrolyte and mechanical strength, and may be porous particles, but are not limited thereto. For example, metal oxides, carbon oxides, carbon-based material, organic-inorganic composites, and the like may be used, alone or in combination of two or more. More specifically, for example, the inorganic particles may be any one selected from SiO₂, Al₂O₃, TiO₂, BaTiO₃, Li₂O, LiF, LiOH, Li₃N, BaO, Na₂O, Li₂CO₃, CaCO₃, LiAlO₂, SrTiO₃, SnO₂, CeO₂, MgO, NiO, CaO, ZnO, ZrO₂, SiC, and the like, or a mixture of two or more. Though not limited thereto, by using the inorganic particles, high affinity with an organic solvent and high thermal stability may be obtained to improve thermal stability of the electrochemical device.

An average diameter of the inorganic particles is not limited, but may be 0.001 μm to 10 μm. Specifically, the average diameter may be 0.1to 10 μm, and more specifically 0.1to 5 μm. When the average diameter of the inorganic particles satisfies the above range, excellent mechanical strength and stability of the electrochemical device may be implemented.

The content of the inorganic particles in the gel polymer electrolyte composition may be 1to 50 wt %, specifically 5to 40 wt %, and more specifically 10to 30 wt %, and the inorganic particles may be used at a content satisfying the viscosity range described above of 0.1 to 10,000,000 cps, preferably 1.0to 1,000,000 cps, and more preferably 1.0to 100,000 cps, but the present invention is not limited thereto.

Next, the embodiment iii) of the positive electrode of the present invention may be a composite electrode in which a composite active material layer including a positive electrode active material, a crosslinked polymer matrix, a solvent, and a dissociable salt is coated on a current collector. Here, since the current collector and the positive electrode active material are as described above, any further description therefor will be omitted.

The composite active material layer may be obtained by light crosslinking or heat crosslinking a crosslinkable monomer and a derivative thereof by an initiator to form a crosslinked polymer matrix.

Therefore, the composite active material layer may be obtained by coating a composite active material composition including a crosslinkable monomer and a derivative thereof, an initiator, a positive electrode active material, and a liquid electrolyte on the current collector, and performing crosslinking by ultraviolet irradiation or heat application, so that the positive electrode active material, the liquid electrolyte, and the like are uniformly distributed in a network structure of a crosslinked polymer matrix, in which a process of evaporating a solvent may not be needed. Here, the coating may be performed by a printing method such as roll-to-roll printing, inkjet printing, gravure printing, gravure offset, aerosol printing, stencil printing, and screen printing as well as a coating method such as bar coating and spin coating, thereby allowing continuous manufacture.

Alternatively, the positive electrode having a composite active material layer formed thereon may be manufactured by casting the composite active material composition on a separate support, peeling off a film from the support, and laminating the obtained film on the current collector. The thickness of the composite active material layer is not limited, but may be 0.01to 500 μm, more specifically 0.1to 200 μm, but is not limited thereto.

An embodiment of the composite active material composition may include 1to 50 wt %, specifically 1to 40 wt, more specifically 2to 30 wt % of a crosslinkable monomer and a derivative thereof in total 100 wt % of the composition, but is not limited thereto. The initiator may be included at 0.01to 50 wt %, specifically 0.01to 20 wt %, and more specifically 0.1to 10 wt %, but is not limited thereto. The content of the positive electrode active material may be 1to 95 wt %, specifically 1to 90 wt %, and more specifically 5to 80 wt %, but is not limited thereto. The liquid electrolyte may be included at 1to 95 wt %, specifically 1to 90 wt %, and more specifically 2to 80 wt %, but is not limited thereto. In addition, if necessary, a conductive material may be further included, and the content of the conductive material may be 0.1to 20 wt %, specifically 1to 10 wt %, but is not limited thereto.

As the crosslinkable monomer, a monomer having two or more functional groups or a mixture of a monomer having two or more functional groups and a monomer having one functional group may be used, and any light-crosslinkable or heat-crosslinkable monomer may be used without limitation.

Specific examples of the monomer having two or more functional groups include any one selected from polyethyleneglycol diacrylate, polyethyleneglycol dimethacrylate, triethyleneglycol diacrylate, triethyleneglycol dimethacrylate, trimethylolpropane ethoxylate triacrylate, trimethylolpropane ethoxylate trimethacrylate, bisphenol A ethoxylate diacrylate, bisphenol A ethoxylate dimethacrylate, and the like, or a mixture of two or more.

In addition, the monomer having one functional group may be any one selected from methylmethacrylate, ethylmethacrylate, butylmethacrylate, methylacrylate, butylacrylate, ethyleneglycol methyletheracrylate, ethyleneglycol methylethermethacrylate, acrylonitrile, vinylacetate, vinylchloride, vinylfluoride, and the like, or a mixture of two or more.

As the initiator, any initiator may be used without limitation as long as it is a photoinitiator or thermal initiator commonly used in the art.

The liquid electrolyte may include dissociable salts and solvents, and may have the same composition as the liquid electrolyte used in the gel polymer electrolyte. Though not limited thereto, specific examples of the dissociable salt include any one selected from lithium hexafluorophosphate (LiPF₆), lithium tetrafluoroborate (LiBF₄), lithium hexafluoroantimonate (LiSbF₆), lithium hexafluoroacetate (LiAsF₆), lithium difluoromethanesulfonate (LiC₄F₉SO₃), lithium perchlorate (LiClO₄), lithium aluminate (LiAlO₂), lithium tetrachloroaluminate (LiAlCl₄), lithium chloride (LiCl), lithium iodide (LiI), lithium bisoxalatoborate (LiB(C₂O₄)₂), lithium tri fluoromethanesulfonylimide (LiN(CₓF₂ₓ₊₁SO₂) (C_{y}F_{2y+1}SO₂)) (wherein x and y are a natural number), and derivatives thereof, or a mixture of two or more. The concentration of the dissociable salt may be 0.1 to 10.0 M, more specifically 1to 5 M, but is not limited thereto.

As the solvent, any one selected from organic solvents such as carbonate-based solvents, nitrile-based solvents, ester-based solvents, ether-based solvents, ketone-based solvents, glyme-based solvents, alcohol-based solvents, and nonprotic solvents, and water, or a mixed solvent of two or more may be used.

As the carbonate-based solvent, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like may be used.

As the nitrile-based solvent, acetonitrile, succinonitrile, adiponitrile, sebaconitrile, and the like may be used.

As the ester-based solvent, methyl acetate, ethyl acetate, n-propyl acetate, 1,1-dimethyl acetate, methylpropionate, ethylpropionate, γ-butylolactone, decanolide, valerolactone, mevalonolactone, caprolactone, and the like may be used.

As the ether-based solvent, dimethylether, dibutylether, tetraglyme, digylme, dimethoxyethane, 2-methyltetrahydrofuran, tetrahydrofuran, and the like may be used, and as the ketone-based solvent, cyclohexanone and the like may be used.

As the glyme-based solvent, ethyleneglycol dimethylether, triethyleneglycol dimethylether, tetraethyleneglycol dimethyether, and the like may be used.

As the alcohol-based solvent, ethylalcohol, isopropylalcohol, and the like may be used, and as the nonprotic solvent, nitriles such as R—CN (R is a linear, branched or cyclic C2to C20 hydrocarbon group, and may include a double bond aromatic ring or an ether bond), amides such as dimethylformamide, dioxolanes such as 1,3-dioxolane, sulfolanes, and the like may be used.

The solvent may be used alone or in combination of one or more, and a mixing ratio when in combination of one or more may be appropriately adjusted depending on the desired battery performance, which may be widely understood by a person skilled in the art.

<Negative Electrode>

In an embodiment of the present invention, the negative electrode may be formed in various embodiments, and specifically, for example, may be selected from an electrode composed of only a current collector, an electrode in which an active material layer including a negative electrode active material and a binder is coated on a current collector, and a composite electrode in which a composite active material layer including a negative electrode active material, a crosslinked polymer matrix, and a liquid electrolyte is coated on a current collector. More preferably, the negative electrode may include a liquid electrolyte or a gel polymer electrolyte from the viewpoint of improving ion conductivity.

More specifically, for example, the negative electrode may be selected from an electrode composed of only a current collector, i) an electrode-electrolyte composite in which a gel polymer electrolyte is applied on the current collector, ii) an electrode-electrolyte composite in which an active material layer including an electrode active material and a binder is included on the current collector and the gel polymer electrolyte is applied on the active material layer, and iii) an electrode-electrolyte composite in which a composite active material layer including an electrode active material, a crosslinked polymer matrix, a solvent, and a dissociable salt is included on the current collector.

More preferably, the negative electrode may be an electrode composed of only a current collector or i) an electrode-electrolyte composite in which a gel polymer electrolyte is applied on the current collector. The gel polymer electrolyte is as described above for the positive electrode.

In the negative electrode of the present invention, the current collector may be in the form selected from the group consisting of a thin film form, a mesh form, a form in which a current collector in the form of a thin film or mesh is laminated on one surface or both surfaces of a conductive substrate and integrated therewith, and a metal-mesh composite. The metal-mesh composite means that a metal in the form of a thin film and a metal or a polymer material in the form of mesh are heated and compressed to be integrated, whereby the metal thin film is put between the holes of the mesh and integrated, and the metal thin film is not broken or does not crack even when the metal thin film is bent. As such, when the metal-mesh composite is used, crack occurrence in the current collector at the time of bending or charging/discharging a battery may be prevented, which is thus more preferred, but the present invention is not limited thereto. The material may be formed of metals such as a lithium metal, aluminum, an aluminum alloy, tin, a tin alloy, zinc, a zinc alloy, a lithium aluminum alloy, and other lithium metal alloys, or a polymer, composites thereof, and the like.

As the negative electrode of the present invention, a current collector in the form of a thin film or mesh may be used as it is, or a current collector in the form of a thin film, a mesh, or a metal-mesh composite may be laminated on a conductive substrate and integrated.

In addition, any current collector may be used without limitation, as long as it is a substrate used in the art, having excellent conductivity. Specifically, for example, the current collector may be formed by including any one selected from a conductive metal, a conductive metal oxide, and the like. In addition, the current collector may be in the form in which the entire substrate is formed of a conductive material or one surface or both surfaces of an insulating substrate is coated with a conductive metal, a conductive metal oxide, a conductive polymer, or the like. In addition, the current collector may be composed of a flexible substrate, and may be easily bent, thereby providing a flexible electronic device. In addition, the current collector may be formed of a material having a restoring force which acts to return a material to its original form after bending the material. More specifically, for example, the current collector may be formed of aluminum, zinc, silver, tin, tin oxide, stainless steel, copper, nickel, iron, lithium, cobalt, titanium, nickel foam, copper foam, a conductive metal-coated polymer substrate, a composite thereof, and the like, but is not limited thereto.

The embodiment ii) of the negative electrode of the present invention may be a form in which a negative electrode active material composition including a negative electrode active material and a binder is applied on a current electrode to coat the current electrode with an active material layer, or an electrode-electrolyte composite in which a gel polymer electrolyte composition is applied on the active material layer to be partially or entirely impregnated into the active material layer so that the gel polymer electrolyte is formed any one or more selected from the inside and the surface.

The current collector is as described above, and the negative electrode active material composition is directly coated on the current collector such as a metal thin film and dried, thereby forming a negative electrode plate on which the negative electrode active material layer is formed. Here, the coating may be performed by a printing method such as inkjet printing, gravure printing, gravure offset, aerosol printing, stencil printing, and screen printing as well as a coating method such as bar coating, spin coating, slot die coating, and dip coating.

Alternatively, the negative electrode having a negative electrode active material layer formed thereon may be manufactured by casting the negative electrode active material composition on a separate support, peeling off a film from the support, and laminating the obtained film on the current collector. The thickness of the negative electrode active material layer is not limited, but may be 0.01to 500 μm, more specifically 0.1to 200 μm, but is not limited thereto.

The negative electrode active material composition is not limited, but may include a negative electrode active material, a binder, and a solvent, and further include a conductive material.

The negative electrode active material may be used without limitation as long as it is commonly used in the art. Specifically, for example, in a lithium primary battery or lithium secondary battery, a compound capable of reversible intercalation and deintercalation of lithium (lithiated intercalation compound) may be used. The negative electrode active material of the present invention may be in the form of powder.

More specifically, for example, the negative electrode active material may be any one selected from metals which may be alloyed with lithium, transition metal oxides, non-transition metal oxides, carbon-based materials, and the like or a mixture of two or more.

As the metal which may be alloyed with lithium, Na, K, Rb, Cs, Fr, Be, Mg, Ca, Sr, Si, Sb, Pb, In, Zn, Ba, Ra, Ge, Al, Sn, and the like may be used, but the present invention is not limited thereto.

The transition metal oxide may be a lithium titanium oxide, a vanadium oxide, a lithium vanadium oxide, and the like, alone or in combination of two or more.

The non-transition metal oxide may be Si, SiOₓ (0<x<2), a Si—C composite, a Si—Q alloy (Q is an alkali metal, an alkali earth metal, an element of Groups 13to 16, a transition metal, a rare-earth element, or a combination thereof, but is not Si), Sn, SnO₂, a Sn—C composite, Sn—R (R is an alkali metal, an alkali earth metal, an element of Groups 13to 16, a transition metal, a rare-earth element, or a combination thereof, but is not Sn), and the like. A specific element of Q and R may be any one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and the like, or a mixture of two or more.

As the carbon-based material, any one selected from crystalline carbon, amorphous carbon, and a combination thereof or a mixture of two or more may be used. Examples of the crystalline carbon include graphite such as amorphous, plate, flake, spherical, or fibrous natural graphite and artificial graphite, and examples of the amorphous carbon include soft carbon, hard carbon, mesophase pitch carbides, calcined cokes, and the like, but are not limited thereto.

Though not limited thereto, the negative electrode active material may be included at 1to 90 wt %, more preferably 5to 80 wt %, in the total weight of the composition. In addition, the negative electrode active material may have an average particle diameter of 0.001 to 20 μm, more specifically 0.01to 15 μm, but is not limited thereto.

The binder serves to adhere negative electrode active material particles to each other and fix the negative electrode active material to the current collector. Any binder commonly used in the art may be used without limitation, and representative examples thereof include polyvinyl alcohol, carboxylmethyl cellulose, hydroxypropyl cellulose, polyvinyl chloride, carboxylated polyvinyl chloride, polyvinyl fluoride, a polymer including ethylene oxide, polyvinylpyrrolidine, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. The solvent may be any one selected from N-methyl pyrrolidone, acetone, water, and the like or a mixture of two or more thereof, but is not limited thereto, and any solvent commonly used in the art may be used.

In addition, the negative electrode active material composition may further include a conductive material.

The conductive material is used for imparting conductivity to the electrode, and any conductive material may be used as long as it does not cause any chemical change in the configured battery and is an electron conductive material. Examples thereof include conductive materials including carbon-based materials such as natural graphite, artificial graphite, carbon black, acetylene black, ketjen black, and carbon fiber; metal-based materials such as metal powder or metal fiber of copper, nickel, aluminum, silver, and the like; conductive polymers such as a polyphenylene derivative; or a mixture thereof. The content of the conductive material may be 1to 90 wt %, more specifically 5to 80 wt %, in the negative electrode active material composition, but is not limited thereto.

In addition, an average particle diameter of the conductive material may be 0.001to 100 μm, more Specifically 0.01to 80 μm, but is not limited thereto. Next, the embodiment iii) of the negative electrode of the present invention may be an electrode-electrolyte composite including a composite active material layer including in which a composite active material layer including a negative electrode active material, a crosslinked polymer matrix, and a liquid electrolyte is included on a current collector. Here, since the current collector and the negative electrode active material are as described above, any further description therefor will be omitted.

A kind of crosslinked polymer matrix may be the same as or different from a kind of polymer matrix used in the gel polymer electrolyte, but from the viewpoint of further improving close adhesive strength and interface adhesive strength and further improving ion conductivity, it is preferred that the crosslinked polymer matrix forms the same polymer and crosslinked density.

The composite active material layer may be obtained by light crosslinking or heat crosslinking a crosslinkable monomer and a derivative thereof by an initiator to form a crosslinked polymer matrix.

Therefore, the composite active material layer may be obtained by coating the current collector with a composite active material composition including a crosslinkable monomer and a derivative thereof, an initiator, a negative electrode active material, and a liquid electrolyte, and performing crosslinking by ultraviolet irradiation or heat application, so that the negative electrode active material, the liquid electrolyte, and the like are uniformly distributed in a network structure of a crosslinked polymer matrix, in which a process of evaporating a solvent may not be needed. Here, the coating may be performed by a printing method such as roll-to-roll printing, inkjet printing, gravure printing, gravure offset, aerosol printing, and screen printing as well as a coating method such as bar coating and spin coating, thereby allowing continuous manufacture.

Alternatively, the negative electrode having a composite active material layer formed thereon may be manufactured by casting the composite active material composition on a separate support, peeling off a film from the support, and laminating the obtained film on the current collector. The thickness of the composite active material layer is not limited, but may be 0.01to 500 μm, more specifically 0.1to 200 μm, but is not limited thereto.

Since the composite active material composition has the same composition used in the positive electrode, further description therefor will be omitted.

<Separator>

In an embodiment of the present invention, the electrode assembly may further include one or more separators between the positive electrode and the negative electrode. The separator may be used from the viewpoint of improving mechanical strength, and for further improving ion conductivity, a liquid electrolyte may be impregnated thereinto. Alternatively, a gel polymer electrolyte including a crosslinked polymer matrix, a solvent, and a dissociable salt may be included.

The separator may be used without limitation as long as it is commonly used in the art. For example, the separator may be formed of a woven fabric, a nonwoven fabric, a porous film, or the like. In addition, the separator may be a multilayer film in which one or two or more layers are laminated. The material of the separator is not limited, but specifically, for example, may be formed of any one selected from the group consisting of polyethylene, polypropylene, polybutylene, polypentene, polymethylpentene, polyethylene terephthalate, polybutylene terephthalate, polyacetal, polyamide, polycarbonate, polyimide, polyethersulfone, polyphenylene oxide, polyphenylene sulfide, polyethylene naphthalene, a copolymer thereof, and the like, or a mixture of two or more. In addition, the thickness thereof is not limited, and may be in a range of 1to 1000 μm, more specifically 10 to 800 μm, which are ranges commonly used in the art, but is not limited thereto.

In an embodiment of the present invention, when the separator is included as such, the electrode assembly may be manufactured by placing the separator on a positive electrode, applying the gel polymer electrolyte composition, performing impregnating and curing, and laminating a negative electrode thereon, but the present invention is not limited thereto.

In an embodiment of the present invention, the electrode assembly may include an electrolyte layer between the negative electrode and the positive electrode, thereby preventing electrical short circuit of the positive electrode and the negative electrode. The electrolyte layer may be a gel polymer electrolyte layer. In addition, in the electrolyte layer, inorganic particles such as alumina and silica may be present to be dispersed for improving mechanical strength. In addition, the electrolyte layer may further include the separator.

In an embodiment of the present invention, in the electrode assembly, the electrolyte used in the positive electrode and the electrolyte used in the negative electrode may be different from each other. That is, any one or two or more compositions of the components forming the electrolyte layer may be different from each other, or the contents thereof may be different.

In an embodiment of the present invention, the electrode assembly may further include gel polymer electrolyte layers which are composed of different compositions and face each other on the negative electrode and the positive electrode. That is, the electrode assembly may include at least two or more different kinds of gel polymer electrolytes composed of different compositions from each other, and each gel polymer electrolyte may be integrated on the positive electrode and the negative electrode. A separate separator may not be needed by the gel polymer electrolyte.

In an embodiment of the present invention, the electrode assembly further includes a first gel polymer electrolyte layer including a polymer matrix, a solvent, and a dissociable salt on a positive electrode, and further include a second gel polymer electrolyte layer including a polymer matrix, a solvent, and a dissociable salt on the negative electrode, in which the first gel polymer electrolyte layer and the second gel polymer electrolyte layer may be composed of different compositions from each other and face each other.

“Facing each other” includes facing by direct close adhesion or facing in a separate state. In addition, “different compositions from each other” means that kinds of any one or two or more components among the components forming the first gel polymer electrolyte layer and the second gel polymer electrolyte layer are different from each other or the contents thereof are different from each other. More preferably, the compositions may have different energy levels or different solubility parameters from each other.

As such, since a gel polymer electrolyte layer having different chemical compositions from each other on the positive electrode and the negative electrode to have different energy levels or solubility parameters from each other may be formed by including at least two or more different kinds of gel polymer electrolytes, liquid electrolyte components are not mixed with each other, and thus, a battery having different kinds of electrolyte layers may be manufactured, and an electrochemical device having a wide range of potential window may be provided. In addition, by forming the gel polymer electrolyte layer in contact with the positive electrode and the gel polymer electrolyte layer in contact with the negative electrode in a state of being not mixed and separated, different kinds of functional additives from each other may be added, and an electrochemical device having excellent oxidation/reduction stability may be provided and performance such as a life characteristic of the electrochemical device may be improved, as compared with the conventional case of using one kind of electrolyte layer.

More specifically, there may be provided an electrochemical device which is composed of electrolytes having electrochemical properties optimized for each electrode (negative electrode and positive electrode) and in which each electrolyte is physically and chemically bonded by a polymer matrix, so that liquid electrolyte components are not mixed with each other even in the case in which each gel polymer electrolyte layer is joined to each other. Specifically, there may be provided an electrochemical device in which a solid electrolyte in which the gel polymer electrolyte in contact with the negative electrode has a low reduction potential and the gel polymer electrolyte in contact with the positive electrode has a high oxidation potential is used to inhibit a side reaction while having a wide potential window, and solubility parameters of each of the gel polymer electrolytes are different from each other and not mixed with each other. When manufactured as such, an electrochemical device which does not require an additional liquid electrolyte and a separator, and has better charge/discharge efficiency and life characteristic of a battery as compared with the case of using a solid electrolyte, by using the gel polymer electrolyte, may be provided. In addition, an electrochemical device which may further include a separator, if necessary, to attempt stability for internal short circuit of a battery and improve mechanical physical properties, may be provided.

That is, in an embodiment of the electrode assembly of the present invention, a positive electrode-electrolyte combination in which a positive electrode is coated with a first gel polymer electrolyte and a negative electrode-electrolyte combination in which a negative electrode is coated with a second gel polymer electrolyte are included, and the first gel polymer electrolyte and the second gel polymer electrolyte may be formed of different compositions from each other and face each other.

Here, the positive electrode and the negative electrode may be selected from an electrode formed of only a current collector, an electrode in which an active material layer including an electrode active material and a binder is coated on a current collector, and a composite electrode in which a composite active material layer including an electrode active material, a crosslinked polymer matrix, and a liquid electrolyte is coated on a current collector, respectively, which is as described above.

The positive electrode-electrolyte combination means that the positive electrode and the first gel polymer electrolyte layer are integrated. Here, the first gel polymer electrolyte layer may be formed of one layer or in the form of a laminate of two or more layers, and the number of layers is not limited. In addition, integration means physical combination by overlapping each other, in which the first gel polymer electrolyte layer may be formed by being coated on the positive electrode and the coating solution is applied to a positive electrode surface and between holes by coating so that the first gel polymer electrolyte layer may be formed more uniformly and closely.

The first gel polymer electrolyte layer may be continuously manufactured by coating the first gel polymer electrolyte composition on the positive electrode by a printing method such as roll-to-roll printing, inkjet printing, gravure printing, gravure offset, aerosol printing, and screen printing. The first gel polymer electrolyte layer may be obtained by light-crosslinking or heat-crosslinking a crosslinkable monomer and a derivative thereof by an initiator to form a crosslinked polymer matrix. The mechanical strength and the structural stability of the gel polymer electrolyte layer are improved by crosslinking, and when the gel polymer electrolyte is coupled to the positive electrode of the embodiment described above, structural stability of the gel polymer electrolyte layer and the positive electrode interface may be further improved.

Accordingly, the first gel polymer electrolyte layer may be obtained by coating a positive electrode with the first gel polymer electrolyte composition including a crosslinkable monomer and a derivative thereof, an initiator, and a liquid electrolyte, and irradiating ultraviolet rays or applying heat to perform crosslinking, so that the liquid electrolyte and the like are uniformly distributed in a network structure of a crosslinked polymer matrix, in which a process of evaporating a solvent may not be needed. It is preferred that the first gel polymer electrolyte composition has a viscosity appropriate for a printing process, and specifically, for example, has a viscosity of 0.1to 10,000,000 cps, preferably 1.0 to 1,000,000 cps, and more preferably 1.0to 100,000 cps, as measured by a brookfield viscometer at 25° C., and within the range, the viscosity is suitable for being applied to a printing process, and thus, the range is preferred, but the present invention is not limited thereto.

The first gel polymer electrolyte composition may include 1to 50 wt %, specifically 2to 40 wt % of a crosslinkable monomer and a derivative thereof in total 100 wt % of the composition, but is not limited thereto. The initiator may be included at 0.01to 50 wt %, specifically 0.01to 20 wt %, and more specifically 0.1to 10 wt %, but is not limited thereto. The liquid electrolyte may be included at 1to 95 wt %, specifically 1to 90 wt %, and more specifically 2to 80 wt %, but is not limited thereto.

Since the kinds of the crosslinkable monomer and the derivative thereof, the initiator, and the liquid electrolyte are as described above for the composite active material composition, repeated description will be omitted. In addition, a monomer used in the first gel polymer electrolyte composition may be formed of the same or different composition as/from the monomer used in the composite active material composition. More preferably, close adhesive strength may be further improved using the same monomer.

In addition, the polymer matrix of the first gel polymer electrolyte layer may further include a linear polymer to form a semi-interpenetrating polymer network (semi-IPN) structure. In this case, the first gel polymer electrolyte layer and the positive electrode-electrolyte combination have excellent flexibility and when used in a battery, show strong resistance to stress such as bending, thereby allowing the battery to normally drive without deterioration of performance. Therefore, it may be applied to a flexible battery or the like.

The linear polymer is easily mixed with the crosslinkable monomer, and may be used without limitation as long as it may be impregnated into a liquid electrolyte. Specifically, for example, the linear polymer may be any one selected from poly(vinylidene fluoride) (PVdF), poly(vinylidene fluoride)-co-hexafluoropropylene (PVdF-co-HFP), polymethylmethacryalte (PMMA), polystyrene (PS), polyvinylacetate (PVA), polyacrylonitrile (PAN), polyethylene oxide (PEO), and the like, or a combination of two or more, but is not limited thereto.

The linear polymer may be included at 1to 90 wt % with respect to the weight of the crosslinked polymer matrix. Specifically, the linear polymer may be included at 1to 80 wt %, 1to 70 wt %, 1to 60 wt %, 1to 50 wt %, 1 to 40 wt %, or 1to 30 wt %. That is, when the polymer matrix has a semi-interpenetrating polymer network (semi-IPN) structure, the crosslinkable polymer and the linear polymer may be included in a range of a weight ratio of 99:1to 10:90. When the linear polymer is included in the above range, the crosslinked polymer matrix may secure flexibility while retaining appropriate mechanical strength. Accordingly, when the linear polymer is applied to a flexible battery, stable battery performance may be implemented even in the case of shape deformation by various external forces, and may suppress danger such as battery fire and explosion resulting from shape deformation of a battery.

In addition, the first gel polymer electrolyte composition may further include inorganic particles, if necessary. The inorganic particles allow printing by controlling rheological properties such as viscosity of the first gel polymer electrolyte composition. The inorganic particles may be used for improving ion conductivity of an electrolyte and mechanical strength, and may be porous particles, but are not limited thereto. For example, metal oxides, carbon oxides, carbon-based material, organic-inorganic composites, and the like may be used, alone or in combination of two or more. More specifically, for example, the inorganic particles may be any one selected from SiO₂, Al₂O₃, TiO₂, BaTiO₃, Li₂O, LiF, LiOH, Li₃N, BaO, Na₂O, Li₂CO₃, CaCO₃, LiAlO₂, SrTiO₃, SnO₂, CeO₂, MgO, NiO, CaO, ZnO, ZrO₂, SiC, and the like, or a mixture of two or more. Though not limited thereto, by using the inorganic particles, high affinity with an organic solvent and high thermal stability may be obtained to improve thermal stability of the electrochemical device.

An average diameter of the inorganic particles is not limited, but may be 0.001 μm to 10 μm. Specifically, the average diameter may be 0.1to 10 μm, and more specifically 0.1to 5 μm. When the average diameter of the inorganic particles satisfies the above range, excellent mechanical strength and stability of the electrochemical device may be implemented.

The content of the inorganic particles in the first gel polymer electrolyte composition may be 1to 50 wt %, specifically 5to 40 wt %, and more specifically 10to 30 wt %, and the inorganic particles may be used at a content satisfying the viscosity range described above of 0.1 to 10,000,000 cps, preferably 1.0to 1,000,000 cps, and more preferably 1.0to 100,000 cps, but the present invention is not limited thereto.

In addition, the first gel polymer electrolyte composition may further include a flame retardant, if necessary, or further include a positive electrode heating inhibitor which is any one selected from succinonitrile and sebaconitrile or a mixture thereof. The content may be in a range of 0.01to 10 wt %, and more specifically 0.1to 10 wt % in the first gel polymer electrolyte composition, but is not limited thereto.

Any flame retardant may be used without limitation, as long as it is a phosphate-based flame retardant commonly used in the art, and the content thereof may be in a range of 0.01to 10 wt %, and more specifically 0.1to 10 wt % in the first gel polymer electrolyte composition, but is not limited thereto.

The thickness of the first gel polymer electrolyte layer may be 0.01 μm to 500 μm. Specifically, the thickness may be 5to 100 μm. When the thickness of the first gel polymer electrolyte layer satisfies the above range, easiness of a manufacturing process is promoted, while performance of the electrochemical device is improved, but the thickness is not limited thereto.

In addition, the first gel polymer electrolyte layer may form a gradient in which a crosslinking density is increasingly lowered from the surface to the positive electrode. By forming a crosslinking density gradient, a charge/discharge cycle may be further improved. In addition, when the crosslinking density is increased, mechanical strength and structural stability are improved, but the ion conductivity of the gel polymer electrolyte may be decreased due to the dense polymer structure. When the crosslinking density gradient is formed, the trade-off problem may be solved, that is, the ion conductivity problem as well as mechanical strength and structural stability may be solved.

In an embodiment of the present invention, the first gel polymer electrolyte layer may be composed of a multilayer structure including two or more layers. More specifically, the first gel polymer electrolyte layer may have a two-layer structure including a first layer and a second layer or may be composed of three layers, and the number of the layers is not limited.

Here, the two or more layers may be formed of the same or different compositions from each other. More specifically, a first layer directly facing the positive electrode may have a gradient in which a crosslinking density or a salt concentration is different from a second layer. Specifically, the second layer may have a higher crosslinking density or a higher salt concentration than the first layer. When the gradient is formed as such, ion conductivity may be further increased and a side reaction may be inhibited, which is thus preferred.

In addition, if necessary, a separator may be further included between two or more of the first gel polymer electrolyte layers.

In an embodiment of the present invention, a negative electrode-electrolyte combination means that the negative electrode and the second gel polymer electrolyte layer are integrated. The negative electrode and the second gel polymer electrolyte layer may be separated, or a part or all of the second gel polymer electrolyte layer may be permeated into the negative electrode and integrated. Here, the second gel polymer electrolyte layer may be formed of one layer or in the form of a laminate of two or more layers, and the number of layers is not limited. In addition, integration means physical combination by overlapping each other, in which the second gel polymer electrolyte layer may be formed by being coated on the negative electrode and the coating solution is applied to a negative electrode surface and between holes by coating so that the second gel polymer electrolyte layer may be formed more uniformly and closely.

The second gel polymer electrolyte layer may be continuously manufactured by coating the second gel polymer electrolyte composition on the negative electrode by a printing method such as roll-to-roll printing, inkjet printing, gravure printing, gravure offset, aerosol printing, and screen printing.

The second gel polymer electrolyte layer may be obtained by light-crosslinking or heat-crosslinking a crosslinkable monomer and a derivative thereof by an initiator to form a crosslinked polymer matrix. The mechanical strength and the structural stability of the gel polymer electrolyte layer are improved by crosslinking, and when combined to the negative electrode of the embodiment exemplified above, structural stability of the gel polymer electrolyte layer and the negative electrode interface may be further improved.

Accordingly, the second gel polymer electrolyte layer may be obtained by coating a negative electrode with the second gel polymer electrolyte composition including a crosslinkable monomer and a derivative thereof, an initiator, and a liquid electrolyte, and irradiating ultraviolet rays or applying heat to perform crosslinking, so that the liquid electrolyte and the like are uniformly distributed in a network structure of a crosslinked polymer matrix, in which a process of evaporating a solvent may not be needed. It is preferred that the second gel polymer electrolyte composition has a viscosity appropriate for a printing process, and specifically, for example, has a viscosity of 0.1to 10,000,000 cps, preferably 1.0 to 1,000,000 cps, and more preferably 1.0to 100,000 cps, as measured by a brookfield viscometer at 25° C., and within the range, a viscosity suitable for a printing process is preferred, but the present invention is not limited thereto.

Since the crosslinkable monomer and the derivative thereof, the initiator, the liquid electrolyte, and the kind and the content of inorganic particles of the second gel polymer electrolyte composition are as described above for the first gel polymer electrolyte composition, further description will be omitted.

However, unlike the positive electrode, a functional additive required for the negative electrode may be included, and the second gel polymer electrolyte composition may further include a flame retardant if necessary or further include an SEI layer stabilizer which is any one selected from vinylene carbonate, fluoroethylene carbonate, and catechol carbonate or a mixture thereof. Vinylene carbonate (VC) may be used for forming a stable SEI layer during the initial charge process, and suppressing a delamination of a carbon layered structure or a direct reaction with an electrolyte to improve a charge/discharge life of a battery. The content of the functional additive may be in a range of 0.01to 30 wt %, and more specifically 0.1to 10 wt % in the first gel polymer electrolyte composition, but is not limited thereto. The thickness of the second gel polymer electrolyte layer may be 0.01 μm to 500 μm. Specifically, the thickness may be 1to 100 μm, and more preferably 5to 50 μm. When the thickness of the second gel polymer electrolyte layer satisfies the above range, easiness of a manufacturing process is promoted, while performance of the electrochemical device is improved, but the thickness is not limited thereto.

In addition, the second gel polymer electrolyte layer may form a gradient in which a crosslinking density is increasingly lowered from the surface to the positive electrode.

In an embodiment of the present invention, the second gel polymer electrolyte layer may be composed of a multilayer structure including two or more layers. More specifically, the second gel polymer electrolyte layer may have a two-layer structure or may be composed of three layers, and the number of the layers is not limited.

Here, the two or more layers may be formed of the same or different compositions from each other. More specifically, a first layer directly facing the negative electrode may have a gradient in which a crosslinking density or a salt concentration is different from a second layer directly facing the first layer. Specifically, the second layer may have a higher crosslinking density or a higher salt concentration than the first layer. When the gradient is formed as such, ion conductivity may be further increased and a side reaction may be inhibited, which is thus preferred.

In addition, the present invention is characterized in that the first gel polymer electrolyte layer and the second gel polymer electrolyte layer are composed of different compositions from each other.

More specifically, different kinds of crosslinking polymers are used, different kinds of organic solvents are used, different kinds of dissociable salts are used, the functional additive is added, or different compositions are used, thereby having different energy levels. Accordingly, a wide range of potential window may be provided. More specifically, the first gel polymer electrolyte layer coupled to the positive electrode has a composition so that it has a highest occupied molecular orbital (HOMO) energy level, and the second gel polymer electrolyte layer coupled to the negative electrode has a composition so that it has a lowest unoccupied molecular orbital (LUMO) energy level, thereby providing a wide range of potential window without a side reaction.

More specifically, the following Equation 1 and Equation 2 may be satisfied:

|Cₑ|<|CE_{H}| [Equation 1]

|Aₑ|<|AE_{L}| [Equation 2]

wherein Cₑ is an energy level of a positive electrode active material, Aₑ is an energy level of a negative electrode active material, CE_{H} is an energy level of HOMO of the first gel polymer electrolyte layer, and AE_{L} is an energy level of LUMO of the second gel polymer electrolyte.

In addition, the first gel polymer electrolyte layer and the second gel polymer electrolyte layer may have an energy level difference of 0.01 eV or more. More specifically, the energy level difference may be 0.01to 7 eV.

The energy level of HOMO is a molecular orbital having the highest energy at which electrons may participate in bonding, and the energy level of LUMO represents a molecular orbital having the lowest energy in a non-bonding area of electrons. The HOMO and LUMO energy levels may be calculated using all methods based on quantum mechanics, and a representative method includes a density functional theory (DFT) and an ab initio molecular orbital method.

The energy level may be changed depending on the kind of salt, the salt concentration, and the kind of solvent.

In addition, in order for the liquid electrolytes used in the first gel polymer electrolyte layer and the second gel polymer electrolyte layer not to be mixed with each other, it is preferred that the first gel polymer electrolyte layer and the second gel polymer electrolyte layer may have a composition having different solubility parameters.

More specifically, the first gel polymer electrolyte layer and the second gel polymer electrolyte may have a difference in solubility parameter of 0.1 MPa^{1/2} or more, more specifically 0.1to 20 Mpa^{1/2}, more preferably 1to 20 Mpa^{1/2}, and still more preferably 2to 20 Mpa^{1/2}.

The solubility parameter may vary with the organic solvent used in the liquid electrolyte.

The solubility parameter may be calculated described in Charles M. Hansen, “Hansen Solubility Parameters: A User's Handbook, 2nd Edition”, 2nd Ed, CRC Press, 2007, as selection criteria for representing incompatibility with each other.

From the above point of view, the first gel polymer electrolyte layer includes a carbonate-based organic solvent as a solvent, and the second gel polymer electrolyte layer may include an ether-based organic solvent as an organic solvent. More specifically, the carbonate-based solvent may be any one selected from dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC), or a mixture of two or more. More specifically, the carbonate-based solvent may be any one selected from ethylene carbonate, propylene carbonate, dimethyl carbonate, diethyl carbonate, and ethylmethyl carbonate, or a mixture of two or more.

The ether-based solvent may be any one selected from dimethyl ether, dibutyl ether, tetraglyme, diglyme, dimethoxyethane, 2-methyltetrahydrofuran, and tetrahydrofuran, or a mixture of two or more.

In addition, the salt concentrations of the first gel polymer electrolyte layer and the second gel polymer electrolyte layer may be different, and at least one layer of the first gel polymer electrolyte layer and the second gel polymer electrolyte layer may have a salt concentration of 2 mol or more. More preferably, it is preferred that the salt concentration of the second gel polymer electrolyte layer laminated on the negative electrode is higher than the salt concentration of the first gel polymer electrolyte layer, and more specifically, the salt concentration of the first gel polymer electrolyte layer is 0.1to 2.5 mol, and the salt concentration of the second gel polymer electrolyte layer is 2 mol or more, and more specifically 3to 10 mol. When the salt concentration of the second gel polymer electrolyte layer is high, a reduction potential is lowered, so that an energy level difference between the first gel polymer electrolyte layer and the second gel polymer electrolyte layer may be further increased. In addition, as the salt concentration is increased, cohesive energy is increased, so that a difference in the solubility parameters of the first gel polymer electrolyte layer and the second gel polymer electrolyte layer may be increased.

Here, even when the first gel polymer electrolyte and the second gel polymer electrolyte use the same solvent and the same salt with an exception to the salt concentration, the energy level or the solubility parameter may vary.

The liquid electrolyte including 1 mol of a commonly used salt has many solvent molecules in a free state which do not participate in solvation, and the solvent molecules which do not participate in solvation are easily electrochemically dissociated to cause a reduced life characteristic of a battery. However, since in the present invention, a high concentration of 2 mol or more of the liquid electrolyte is used, the salt concentration is high, so that most of the solvent participates in solvation, and solvent molecules in a free state which do not participate in solvation hardly exist, and thus, improvement of the life characteristic of a battery may be promoted.

Hereinafter, an embodiment of the electrode assembly 100 of the present invention will be described in detail, with reference to FIGS. 11 to 15. FIGS. 11 to 15 illustrate an embodiment of the electrode assembly of the present invention, and the present invention is not limited thereto.

First, an embodiment including a positive electrode and a negative electrode which are an embodiment of the electrode assembly of the present invention, as one set, will be described in more detail, with reference to FIG. 11. As shown in FIG. 11, the electrode assembly 100 of the present invention may include a positive electrode 10 in which a positive electrode active material layer 12 is laminated on a positive electrode current collector 11 and a negative electrode 20 composed of a negative electrode current collector 21, and may include an electrolyte layer between the positive electrode and the negative electrode. The positive electrode current collector 11 and the negative electrode current collector 21 are as described above, and the positive electrode active material layer 12 may be composed of an active material layer including a positive electrode active material and a binder or composite active material layer including a positive electrode active material, a crosslinked polymer matrix, and a liquid electrolyte.

In addition, as described above, the first gel polymer electrolyte layer may be laminated on the positive electrode or partially or entirely impregnated into and integrated with the positive electrode, and the second gel polymer electrolyte layer may be laminated on the negative electrode.

The electrolyte layer 50 may be a liquid electrolyte or a gel polymer electrolyte layer, but is not limited thereto. In addition, though not shown, one or more separators may be further included in any one or both selected from between the electrolyte layer 50 and the negative electrode 20 and between the electrolyte layer 50 and the positive electrode 10.

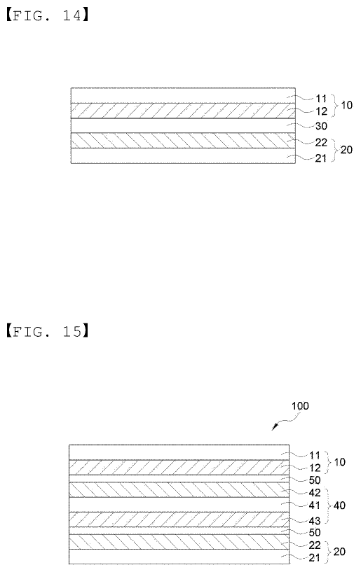

As shown in FIG. 12, the electrode assembly 100 of the present invention may include a positive electrode 10 in which a positive electrode active material layer 12 is laminated on a positive electrode current collector 11, a negative electrode 20 composed of a negative electrode current collector 21, and a separator 30. The positive electrode current collector 11, the negative electrode current collector 21, and the separator 30 are as described above, and the positive electrode active material layer 12 may be composed of an active material layer including a positive electrode active material and a binder or composite active material layer including a positive electrode active material, a crosslinked polymer matrix, and a liquid electrolyte. In addition, as described above, the first gel polymer electrolyte layer may be laminated on the positive electrode or partially or entirely impregnated into and integrated with the positive electrode, and the second gel polymer electrolyte layer may be laminated on the negative electrode.

In addition, though not shown, the separator may be impregnated with an electrolyte. The electrolyte may be a liquid electrolyte or a gel polymer electrolyte, but is not limited thereto.

As shown in FIG. 13, the electrode assembly 100 of the present invention may include a positive electrode 10 in which a positive electrode active material layer 12 is laminated on a positive electrode current collector 11 and a negative electrode 20 in which a negative electrode active material layer 22 is laminated on a negative electrode current collector 21, and may include an electrolyte layer 50 between the positive electrode and the negative electrode. The positive electrode current collector 11 and the negative electrode current collector are as described above, and the positive electrode active material layer 12 and the negative electrode active material layer 22 may be composed of an active material layer including a positive electrode active material and a binder or composite active material layer including a positive electrode active material, a crosslinked polymer matrix, and a liquid electrolyte. In addition, as described above, the first gel polymer electrolyte layer may be laminated on the positive electrode or partially or entirely impregnated into and integrated with the positive electrode, and the second gel polymer electrolyte layer may be laminated on the negative electrode or partially or entirely impregnated into and integrated with the negative electrode.

The electrolyte layer 50 may be a liquid electrolyte or a gel polymer electrolyte layer, but is not limited thereto. In addition, though not shown, one or more separators may be further included in any one or both selected from between the electrolyte layer 50 and the negative electrode 20 and between the electrolyte layer 50 and the positive electrode 10.

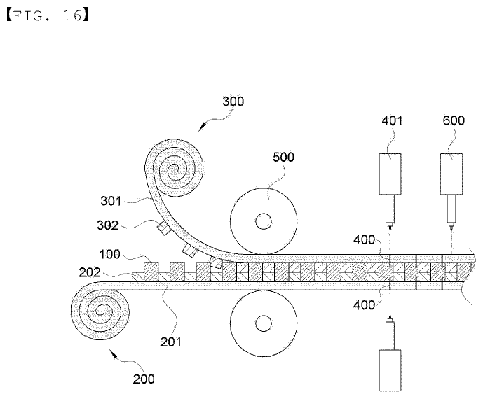

As shown in FIG. 14, the electrode assembly 100 of the present invention may include a positive electrode 10 in which a positive electrode active material layer 12 is laminated on a positive electrode current collector 11, a negative electrode 20 in which a negative electrode active material layer 22 is laminated on a negative electrode current collector 21, and a separator 30. The positive electrode current collector 11, the negative electrode current collector 21, and the separator 30 are as described above, and the positive electrode active material layer 12 and the negative electrode active material layer 22 may be composed of an active material layer including a positive electrode active material and a binder or composite active material layer including a positive electrode active material, a crosslinked polymer matrix, and a liquid electrolyte.

In addition, as described above, the first gel polymer electrolyte layer may be laminated on the positive electrode or partially or entirely impregnated into and integrated with the positive electrode, and the second gel polymer electrolyte layer may be laminated on the negative electrode or partially or entirely impregnated into and integrated with the negative electrode.

In addition, though not shown, the separator may be impregnated with an electrolyte. The electrolyte may be a liquid electrolyte or a gel polymer electrolyte, but is not limited thereto.

As shown in FIG. 15, the electrode assembly 100 of the present invention includes a positive electrode 10 in which a positive electrode active material layer 12 is laminated on a positive electrode current collector 11, a bipolar electrode 40 in which a negative electrode active material layer 42 and a positive electrode active material layer 43 are laminated on a bipolar current collector 41, and a negative electrode 20 in which a negative electrode active material layer 22 is laminated on a negative electrode current collector 21, and may include an electrolyte layer 50 between the positive electrode and the bipolar electrode and between the negative electrode and the bipolar electrode. In addition, though not shown, one or more separators may be further included between the positive electrode active material layer 12 and the negative electrode active material layer 42 and between the positive electrode active material layer 43 and the negative electrode active material layer 22. The separator may be impregnated with an electrolyte. The electrolyte may be a liquid electrolyte or a gel polymer electrolyte, but is not limited thereto. In addition, the bipolar electrode may be a laminate of one or more, but the number of the bipolar electrodes is not limited. The positive electrode current collector 11, the negative electrode current collector 21, and the bipolar current collector 41 are as described above for the current collector, and the positive electrode active material layers 12 and 43 and the negative electrode active material layers 22 and 42 may be composed of an active material layer including a positive electrode active material and a binder or composite active material layer including a positive electrode active material, a crosslinked polymer matrix, and a liquid electrolyte.

In addition, as described above, the first gel polymer electrolyte layer may be laminated on the positive electrode or partially or entirely impregnated into and integrated with the positive electrode, and the second gel polymer electrolyte layer may be laminated on the negative electrode or partially or entirely impregnated into and integrated with the negative electrode.

The electrolyte layer 50 may be a liquid electrolyte or a gel polymer electrolyte layer, but is not limited thereto. In addition, though not shown, one or more separators may be further included in any one or two or more selected from between the electrolyte layer 50 and the negative electrode 20, between the electrolyte layer 50 and the bipolar electrode 40, between the electrolyte layer 50 and the positive electrode 10, and between the electrolyte layer 50 and the bipolar electrode 40.

[Manufacturing Method]

Hereinafter, a method of manufacturing the electrochemical device of the present invention will be described in detail. The manufacturing method of the present invention may continuously produce a plurality of battery cells at the same time, and a single electrochemical device as shown in FIGS. 1 to 6 may be easily manufactured by cutting. In addition, as shown in FIG. 17, an electrochemical device provided with a plurality of cell areas may be easily manufactured.

As shown in FIGS. 10, 16 and 19, the manufacturing method includes a step of supplying a lower sheet 200 including a metal layer 201 and a sealing layer 202 on one surface of the metal layer, the sealing layer 202 forming a partition pattern including a circumferential partition 211 and a compartment partition 212 comparting a space 213 for housing an electrode assembly in an inner side of the circumferential partition, a step of placing an electrode assembly 100 in a space 213 for housing the electrode assembly of the lower sheet 200, and a step of supplying an upper sheet 300 having the same configuration as the lower sheet 200 or an upper sheet 300 including a metal layer without a sealing layer as shown in FIG. 19 and joining the sheets to be sealed.

Here, the electrode assembly 100 may have the positive electrode, the negative electrode, the separator, and the electrolyte which have the same size. Having the same size means that the edges substantially coincide each other, as described above. In addition, in the electrode assembly 100, the size of the separator may be the same as or larger than the size of the negative electrode, and the size of the positive electrode may be the same as or smaller than the size of the negative electrode.

In an embodiment of the present invention, the electrode assembly may be manufactured by punching in the state in which the positive electrode, the separator, and the negative electrode continuously supplied from each roller are laminated, and the sizes of the positive electrode, the separator, and the negative electrode may be substantially the same. More specifically, a gel polymer electrolyte composition is applied in the state in which the positive electrode and the separator are laminated to be impregnated and cured, the negative electrode is laminated, and punching is performed in the laminated state, whereby the electrode assembly having a constant shape may be manufactured.

In addition, in an embodiment of the present invention, the upper sheet and the lower sheet may be continuously supplied from each roller, and the joining may use a common heating and pressing unit 500 such as a heating plate or a heating roller. The polymer material of the sealing layer is melted and attached to each other by heating and pressing so that a sealed state is formed, and the metal layer of the lower sheet and the metal layer of the upper sheet may be closely adhered to the current collector which is the outermost layer of the electrode assembly and electrically connected. A temperature and a pressure during the heating and pressing are preferably a temperature higher than the melting point of the polymer material used in the sealing layer, and may vary depending on the kinds of the polymer materials, and thus, are not limited thereto.

Here, though not shown, if necessary, a step of applying any one or more selected from a conductive adhesive, a conductive pressure-sensitive adhesive, and a conductive paste on the metal layer corresponding to the space 213 for housing the electrode assembly on the upper sheet and the lower sheet, may be further included. In addition, if necessary, a step of applying an adhesive on the sealing layer may be further included.

Next, after joining by the heating and pressing unit 500, a step of welding of soldering a portion in which the metal layer of the lower sheet and the upper sheet and the electrode assembly are closely adhered using a welding unit 401 may be further included to form junction 400. The welding may be formed in the form of spot or stripe by resistance welding, ultrasonic welding, laser welding, or the like, but is not limited thereto. The soldering may further include a soldering paste on the portion in which the metal layer and the electrode assembly are closely adhered to each other.

Next, a step of cutting the closed portion by the sealing layer using a cutting unit 600 may be included to manufacture an electrochemical device 1000 composed of one battery cell, as shown in FIGS. 1 to 6. In addition, an electrochemical device 2000 may be manufactured in which a plurality of battery cells are connected in parallel, as shown in FIG. 17. Here, a method for cutting is not limited as long as it is commonly used in the art, and specifically, for example, cutting may be performed by for example, laser cutting, mold punching, die cutting, and the like, but is not limited thereto.

The present invention is not limited to the above-mentioned exemplary embodiments but may be variously applied, and may be variously modified by those skilled in the art to which the present invention pertains without departing from the gist of the present invention claimed in the claims.

1. An electrode assembly housed in a space formed by an upper sheet and a lower sheet, the upper sheet and the lower sheet facing each other and being integrated, wherein
the upper sheet and the lower sheet include a metal layer,
at least any one or more of the upper sheet and the lower sheet include a sealing layer at an edge of the metal layer, and
current collectors of a positive electrode and a negative electrode of the electrode assembly are closely adhered and electrically connected to the metal layers of the upper sheet and the lower sheet.

2. The electrochemical device of claim 1, further comprising: a junction in at least any one or more portions in which the electrode assembly and the metal layer of the upper sheet and the lower sheet are closely adhered to each other.

3. The electrochemical device of claim 1, further comprising: any one or more conductive layers selected from a conductive adhesive layer, a conductive pressure-sensitive adhesive layer, and a conductive paste layer between any one or more metal layers selected from the metal layers of the lower sheet and the upper sheet and the electrode assembly.

4. The electrochemical device of claim 1, wherein any one or more selected from the upper sheet and the lower sheet further include an insulation layer in an outermost layer, and a part of the insulation layer is opened.

5. The electrochemical device of claim 1, wherein the sealing layer is formed of a heat-fusible polymer material.

6. The electrochemical device of claim 1, wherein the sealing layer includes one or more layers formed of a heat-resistant material between layers formed of the heat-fusible polymer material.

7. The electrochemical device of claim 1, further comprising: an adhesive layer on the sealing layer.

8. The electrochemical device of claim 1, wherein the sealing layer is formed along a circumference of the electrode assembly, at an edge excluding a portion in which the electrode assembly is disposed.

9. The electrochemical device of claim 1, wherein the electrode assembly includes the positive electrode and the negative electrode, and at least one or more of the positive electrode and the negative electrode include a gel polymer electrolyte including a crosslinked polymer matrix, a solvent, and a dissociable salt.

10. The electrochemical device of claim 9, wherein
the positive electrode is selected from i) an electrode-electrolyte composite in which a gel polymer electrolyte is applied on the current collector, ii) an electrode-electrolyte composite in which an active material layer including an electrode active material and a binder is included on the current collector and the gel polymer electrolyte is applied on the active material layer, and iii) an electrode-electrolyte composite in which a composite active material layer including an electrode active material, a crosslinked polymer matrix, a solvent, and a dissociable salt is included on the current collector, and
the negative electrode is selected from an electrode composed of only the current collector and i) to iii).

11. The electrochemical device of claim 10, wherein the positive electrode is selected from ii) and iii), and
the negative electrode is composed of only the current collector or selected from i).

12. The electrochemical device of claim 10, wherein the active material layer and the composite active material layer further include a conductive material.

13. The electrochemical device of claim 9, wherein the positive electrode and the negative electrode substantially coincide on an edge.

14. The electrochemical device of claim 13, wherein at least one or more separators are further included between the positive electrode and the negative electrode, and the separator substantially coincide with the positive electrode and the negative electrode on the edge.

15. The electrochemical device of claim 14, wherein the separator includes a gel polymer electrolyte including the crosslinked polymer matrix, the solvent, and the dissociable salt.

16. The electrochemical device of claim 9, wherein the electrode assembly includes a first gel polymer electrolyte in the positive electrode and a second gel polymer electrolyte in the negative electrode, and the first gel polymer electrolyte and the second gel polymer electrolyte are different from each other.

17. The electrochemical device of claim 16, wherein the first gel polymer electrolyte and the second gel polymer electrolyte have a difference in solubility parameter of 0.1 Mpa^{1/2} or more.

18. The electrochemical device of claim 16, wherein the first gel polymer electrolyte and the second gel polymer electrolyte have an energy level difference of 0.01 eV or more.

19. The electrochemical device of claim 16, wherein the first gel polymer electrolyte and the second gel polymer electrolyte further include any one or two or more additives selected from inorganic particles and a flame retardant.

20. The electrochemical device of claim 16, wherein
the first gel polymer electrolyte further includes a positive electrode heating inhibitor which is any one selected from succinonitrile and sebaconitrile or a mixture thereof, and
the second gel polymer electrolyte further includes an SEI layer stabilizer which is any one selected from vinylene carbonate, fluoroethylene carbonate, and catechol carbonate, or a mixture thereof.

21. The electrochemical device of claim 9, wherein the crosslinked polymer matrix further includes a linear polymer to have a semi-interpenetrating polymer network (semi-IPN) structure.

22. The electrochemical device of claim 1, wherein each of the positive electrode current collector and the negative electrode current collector electrochemical device are selectively in a form selected from the group consisting of a thin film form, a mesh form, a form in which a current collector in a form of a thin film or mesh is laminated on one surface or both surfaces of a conductive substrate and integrated therewith, and a metal-mesh composite.

23. The electrochemical device of claim 1, wherein the electrochemical device is a laminate of one or two or more electrode assemblies.

24. The electrochemical device of claim 1, wherein the electrode assembly includes one or more bipolar electrodes.

25. The electrochemical device of claim 1, wherein
the sealing layer further includes a plurality of compartment partitions so that a plurality of grooves having no sealing layer formed therein are formed, and a plurality of electrode assemblies are included in a space formed by the upper sheet and the lower sheet facing each other and being integrated, so that a plurality of cell areas are provided.

26. The electrochemical device of claim 1, wherein the electrochemical device is a primary battery or a secondary battery capable of an electrochemical reaction.

27. The electrochemical device of claim 26, wherein the electrochemical device is selected from the group consisting of a lithium primary battery, a lithium secondary battery, a lithium-sulfur battery, a lithium-air battery, a sodium battery, an aluminum battery, a magnesium battery, a calcium battery, a zinc battery, a zinc-air battery, a sodium-air battery, an aluminum-air battery, a magnesium-air battery, a calcium-air battery, a super capacitor, a dye-sensitized solar battery, a fuel battery, a lead storage battery, a nickel cadmium battery, a nickel hydrogen storage battery, and an alkaline battery.

28. A method of continuously manufacturing an electrochemical device, the method comprising:
supplying a lower sheet including a metal layer and a sealing layer on one surface of the metal layer, the sealing layer forming a partition pattern including a circumferential partition and a compartment partition comparting a space for housing an electrode assembly in an inner side of the circumferential partition,
laminating the electrode assembly in the space of the lower sheet for housing the electrode assembly, and
supplying an upper sheet including the metal layer and joining the sheets.

29. The method of manufacturing an electrochemical device of claim 28, wherein during the joining, a positive electrode current collector and a negative electrode current collector of the electrode assembly are joined so that they are closely adhered to the metal layers of the upper sheet and the metal layer of the lower sheet, respectively.

30. The method of manufacturing an electrochemical device of claim 28, further comprising: forming a junction by welding or soldering a portion in which the metal layers of the lower sheet and the upper sheet and the electrode assembly are closely adhered, after the joining.

31. The method of manufacturing an electrochemical device of claim 28, further comprising: applying any one or more selected from a conductive adhesive, a conductive pressure-sensitive adhesive, and a conductive paste on the metal layers of the lower sheet and the upper sheet.

32. The method of manufacturing an electrochemical device of claim 28, further comprising: cutting a portion sealed by the sealing layer.
